(19) United States
(12) Patent Application Publication
(10) Pub. No.: US 2007/0051769 A1
(43) Pub. Date: Mar. 8, 2007

(54) Brittle substrate cutting system and brittle substrate cutting method

(75) Inventors: Kenji Otoda, Osaka (JP); Shuichi Inoue, Osaka (JP)

Correspondence Address: SNELL & WILMER, 400 EAST VAN BUREN, ONE ARIZONA CENTER, PHOENIX, AZ, 85004-2202, US

(73) Assignee: MITSUBOSHI DIAMOND INDUSTRIAL CO., LTD., Osaka (JP)

(21) Appl. No.: 10/554,855

(22) PCT Filed: Apr. 27, 2004
(86) PCT No.: PCT/JP04/06103

§ 371 Date: Oct. 18, 2006

(30) Foreign Application Priority Data
Apr. 28, 2003 (JP) 2003-124501

(51) Int. Cl. B26F 3/00

(52) U.S. Cl. 225/2

(57) ABSTRACT

A brittle substrate cutting system according to the present invention includes a scribing apparatus including a scribing line forming means for forming a scribing line on a first surface of a brittle substrate; and a breaking apparatus for breaking the brittle substrate along the scribing line, wherein the breaking apparatus includes a first pressing controlling means for moving a pressing force upon a second surface of the brittle substrate opposing the first surface of the brittle substrate along the scribing line while the first surface of the brittle substrate is held.

### TECHNICAL FIELD

The present invention relates to a brittle substrate cutting system and a brittle substrate cutting method for cutting a brittle substrate by forming a scribing line on the brittle substrate and breaking the brittle substrate along the scribing line.

### BACKGROUND ART

A display apparatus includes a flat display panel (e.g., a liquid crystal panel, a plasma display panel, an organic RL display panel). The flat display panel is manufactured by bonding two brittle substrates (e.g., two glass substrates). When a display panel is manufactured, a brittle substrate needs to be cut into a predetermined size. Generally, a scribe line is formed on the brittle substrate (scribing step), and next the brittle substrate is broken along the scribe line formed (breaking step), thereby the brittle substrate being cut.

WO02/057192A1 discloses a cutting apparatus in which a pair of cutting heads, each head opposing each other on an upper side and a lower side, is provided. Each of the pair of cutting heads includes a cutter wheel for forming a scribing line on a glass substrate and a roller which presses and rolls on the glass substrates in parallel with the scribing line formed by the cutter wheel. The cutting apparatus cuts a bonded substrate which is manufactured by bonding the pair of glass substrates.

The cutting apparatus disclosed in the publication rotates the roller of each cutting head provided on the upper side and the lower side while each roller is pressed against both sides of the scribing line to exert a shearing stress (a bending moment) with respect to the scribing line on each glass substrate after a scribing line is formed simultaneously by a cutter wheel of each cutting head on each glass substrate, which constitutes a bonded substrate. In this manner, each glass substrate is cut.

In the cutting apparatus described in the publication, the bending moment works such that a vertical crack extending right below (right above) the scribing line formed on the respective glass substrates extends in the thickness direction of the glass substrates. However, the bending moment does not exert a sufficient shearing force with respect to each scribing line. Thus, when a vertical crack constituting the scribing line formed on each glass substrate is shallow, there is a possibility that each glass substrate may not be accurately cut.

When a side edge portion of the glass substrate is cut, the cut side edge portion droops since the cut side edge portion is not held. An unnecessary force is applied to the glass substrate during the cutting process by the drooped side edge portion. Therefore, there is a possibility that the substrate is cut in an oblique direction with respect to the scribing line. There is also a possibility that chippings, fractures, etc., may occur at an end face when the cut side edge portion contacts the end face which is the cut portion of the glass substrate.

The present invention is made in view of such problems. The objective thereof is to provide a brittle substrate cutting system and a brittle substrate cutting method for efficiently cutting a brittle substrate without chippings in the brittle substrate and fractures, etc., in the brittle substrate.

### DISCLOSURE OF THE INVENTION

A brittle substrate cutting system according to the present invention includes a scribing apparatus including a scribing line forming means for forming a scribing line on a first surface of a brittle substrate; and a breaking apparatus for breaking the brittle substrate along the scribing line, wherein the breaking apparatus includes a first pressing controlling means for moving a pressing force upon a second surface of the brittle substrate opposing the first surface of the brittle substrate along the scribing line while the first surface of the brittle substrate is held, thereby the above-described objective of the present invention being achieved.

According to a brittle substrate cutting system of the present invention, a pressing force upon a second surface of the brittle substrate is moved along the scribed line formed on a first surface of the brittle substrate while the first surface of the brittle substrate is held, this second surface opposing the first surface of the brittle substrate. In this manner, while the pressing force along the scribing line formed on the first surface of the brittle substrate, the pressing force is applied to the second surface of the brittle substrate, this second surface opposing the first surface of the brittle substrate. Therefore, a bending moment is applied to the brittle substrate such that a vertical crack extending from the scribing line positively extends in the thickness direction of the substrate to cut the brittle substrate.

According to a brittle substrate cutting system of the present invention, the breaking apparatus may further includes: a pressing means for pressing the second surface of the brittle substrate; and a first holding means for holding the first surface of the brittle substrate, wherein the first pressing controlling means may control the pressing means such that the pressing means moves along the scribing line while the first holding means and the pressing means oppose each other with the brittle substrate therebetween.

According to a brittle substrate cutting system of the present invention, a pressing means is moved along the scribing line formed on the first surface of the brittle substrate while a first holding means holds a first surface of the brittle substrate and the pressing means presses a second surface of the brittle substrate. Therefore, a pressing force is applied along the scribing lane of the second surface of the brittle substrate, this second surface opposing the first surface of the brittle substrate on which the scribing line is formed. As a result, a bending moment is applied to the brittle substrate such that a vertical crack extending from the scribing line positively extends in the thickness direction of the substrate to cut the brittle substrate.

According to a brittle substrate cutting system of the present invention, the first pressing controlling means controls the pressing means such that the pressing means rolls along the scribing line.

The first controlling means readily moves along the scribing line since the first pressing controlling means controls the pressing means such that the pressing means rolls along the scribing line.

According to a brittle substrate cutting system of the present invention, the pressing means may be a roller.

Since a roller is used as the pressing means the first pressing controlling means readily rotates the pressing means along the scribing line.

According to a brittle substrate cutting system of the present invention, the pressing means may be a conveyor.

Since a conveyor is used as the pressing means the first pressing controlling means readily rotates the pressing means along the scribing line.

According to a brittle substrate cutting system of the present invention, the pressing means may be a bearing.

Since a bearing is used as the pressing means the first pressing controlling means readily rotates the pressing means along the scribing line.

According to a brittle substrate cutting system of the present invention, a groove section may be formed in the pressing means such that the pressing means does not contact with a line on the second surface of the brittle substrate, the line opposing the scribing line.

When the brittle substrate is cut along the scribing line, the pressing means holds both sides of the line of the second surface of the brittle substrate so as not to contact with the line on the second surface of the brittle substrate, this line opposing the scribing line. Therefore, occurrence of chippings at the cut face portion is prevented during the cutting process.

According to a brittle substrate cutting system of the present invention, the breaking apparatus may further include a first holding controlling means for controlling the first holding means such that the first holding means moves along the scribing line while the first holding means and the pressing means oppose each other with the brittle substrate therebetween.

The first pressing controlling means moves the pressing means along the scribing line and the first holding controlling means moves the first holding means along the scribing line to sequentially cut the brittle substrate from one end face of the brittle substrate to the other end face of the brittle substrate while the first holding means and the pressing means oppose each other with brittle substrate therebetween. Therefore, the brittle substrate is cut without forming a plurality of starting points of cutting. As a result, a cut face is formed without having unevenness on the brittle substrate,

According to a brittle substrate cutting system of the present invention, the first holding controlling means may control the first holdingmeans such that the first holding means rolls along the scribing line.

Since the first holding means controls the first holding means so as to roll along the scribing line, the first holding controlling means readily moves the first holding means along the scribing line.

According to a brittle substrate cutting system of the present invention, the holding means may be a roller.

Since the roller is used as the first holding means, the first holding controlling means readily rotates the first holding means along the scribing line.

According to a brittle substrate cutting system of the present invention, the holding means may be a conveyor.

Since the conveyor is used as the firstholding means, the first holding controlling means readily rotates the first holding means along the scribing line.

According to a brittle substrate cutting system of the present invention, the holding means may be a bearing.

Since the bearing is used as the first holding means, the first holding controlling means readily rotates the first holding means along the scribing line.

According to a brittle substrate cutting system of the present invention, a groove section may be formed in the holding means such that the first holding means does not contact with the scribing line.

When the brittle substrate is cut along the scribing line, the first holding means holds both sides of the scribing line so as not to contact with the scribing line. Therefore, occurrence of chippings at the cut face portion is prevented during the cutting process.

According to a brittle substrate cutting system of the present invention, the width of the groove section formed in the first holding means may be larger than that of the pressing means.

The brittle substrate is positively cut since a portion of the pressing means goes under the first holding means, so that the brittle substrate is likely to bend.

According to a brittle substrate cutting system of the present invention, the pressing means may further include a second holding means and a third holding means for moving along the scribing line in a first direction and for holding the brittle substrate, the second holding means and the third holding means being arranged in the first direction from the pressing means, and the breaking apparatus may further include a second holding controlling means for controlling the second holding means such that the second holding means moves on the first surface along the scribing line while the second holding means holds the brittle substrate, and controlling the third holding means such that the third holding means moves on the second surface along the scribing line while the third holding means holds the brittle substrate.

The holding means is moved along the scribing line while holding the uncut portions of the area on which the scribing line is formed, thereby preventing an unnecessary force being applied to the areas which are being pressed by the pressing means. As a result, chippings at the cut face portion formed on the brittle substrate can be prevented.

According to a brittle substrate cutting system of the present invention, the second holding controlling means controls the second holding means such that the first holding means and the second holding means move at a predetermined speed and the second holding controlling means controls the third holding means such that the third holding means and the pressing means move at the predetermined speed while the second holding means and the third holding means oppose each other with the brittle substrate therebetween.

The second holding means and the third holding means firmly hold the brittle substrate since the first holding means, the second holding means and third holding means move at the same speed.

According to a brittle substrate cutting system of the present invention, the pressing means may further include a fourth holding means and a fifth holding means for moving along the scribing line in a first direction and for holding the brittle substrate, the fourth holding means and the fifth holding means being arranged in a direction opposite to the first direction from the pressing means.

The first holding means is moved along the scribing line while the fourth holding means and the fifth holding means hold the cut portions of the area on which the scribing line is formed, thereby preventing an unnecessary force being applied to the areas which are being pressed by the pressing means. As a result, chippings at the cut face portion formed on the brittle substrate can be prevented.

According to a brittle substrate cutting system of the present invention, the scribing line forming means may include a laser beam irradiating means for irradiating a laser beam on the first surface of the brittle substrate and a cooling means for cooling the vicinity of the portions of the first surface of the brittle substrate where the laser beam is irradiated by the laser beam irradiating means.

A laser beam is irradiated on the first surface of the brittle substrate, and the vicinity of the portions where the laser beam is irradiated is cooled, so that a scribing line with a vertical crack generated therein is formed. Therefore, a stress distortion does not remain in an edge of a cut face. As a result, the cut face portion which is formed on the brittle substrate can be prevented from being chipped when the cut brittle substrate is transported to a different apparatus from the brittle substrate cutting apparatus, the different apparatus being used for a step subsequent to cutting the brittle substrate.

According to a brittle substrate cutting system of the present invention, the cooling means may be a cooling nozzle, and the cooling nozzle may cool the vicinity of the portions where the laser beam is irradiated by spraying a cooling medium on the first surface of the brittle substrate.

A predetermined area of the brittle substrate is positively cooled without contacting the brittle substrate cutting system since the cooling medium is sprayed onto the first surface of the brittle substrate by the cooling nozzle.

A brittle substrate cutting system according to the present invention may include a laser beam/cooling medium receiving section for receiving at least one of the laser beam irradiated by the laser beam irradiating means and the cooling medium sprayed by the cooling nozzle.

Since diffusion o£ at least one of a laser beam and cooling medium is prevented, the safety of the brittle substrate cutting apparatus is improved.

According to a brittle substrate cutting system of the present invention, the laser beam/cooling medium receiving section maybe movable separately from the pressing means.

A brittle substrate on which a scribing line is formed is cut when the pressing means follows the cutter at the time the scribing line is formed. While the scribing line is formed on the first surface of the brittle substrate, a second surface of the brittle material is pressed by the pressing means. Therefore, the scribing step and the breaking step are approximately simultaneously performed. Accordingly, time for a cutting step is reduced.

According to a brittle substrate cutting system of the present invention, the cooling nozzle may be movable along the scribing line.

Since the cooling nozzle is moved along the scribing line, ascribing condition can beset according to the material of the brittle substrate.

According to a brittle substrate cutting system of the present invention, the scribing line forming means further may include a notch forming cutter mechanism for forming a notch at a starting position of forming the scribing line on the first surface of the brittle substrate.

Since a notch is formed at a starting position of forming a scribing line on the first surface of the brittle substrate, a vertical crack extending from the scribing line is positively formed.

According to a brittle substrate cutting system of the present invention, the notch forming cutter mechanism may be integrally movable with the laser beam irradiating means and the cooling means.

The notch formed at the starting position of forming a scribing line, and a laser beam irradiating area and a cooling area are co-aligned. Therefore, the scribing line is accurately formed along the lane on which a scribing line is to be formed.

According to a brittle substrate cutting system of the present invention, the scribing line forming means may be a cutter.

Since a wide selection for conditions of forming a scribing line is available, a scribing line is stably formed.

According to a brittle substrate cutting system of the present invention, the cutter may be a disk-shaped cutter wheel tip, and an edge portion may be formed in an outer circumferential edge of the cutter wheel tip.

Since a scribing line is formed while the cutter wheel tip is pressed and rotated on the brittle substrate, a speed (scribing forming speed) of forming a scribing line is improved.

According to a brittle substrate cutting system of the present invention, a plurality of recessed portions may be formed in a ridge-shaped section of the edge portion with a predetermined distance.

A plurality of recessed portions is formed in ridge-shaped sections of the edge portions with a predetermined distance, so that a plurality of protrusions is formed except where the plurality of recessed portions is formed. When a scribing line is formed, the plurality of protrusions applies a pinpoint shock upon a first surface of the brittle substrate. Therefore, a vertical crack which extends up to about 90% of the thickness of the brittle substrate is formed. As a result, the brittle substrate is positively cut after the breaking step.

According to a brittle-substrate cutting system of the present invention, the cutter may be movable separately from the pressing means.

A brittle substrate on which a scribing line is formed is cut when the pressing means follows the cutter at the time the scribing line is formed. While the scribing line is formed on the first surface of the brittle substrate, a second surface of the brittle material is pressed by the pressing means. Therefore, the scribing step and the breaking step are approximately simultaneously performed. Accordingly, time for a cutting step is reduced.

According to a brittle substrate cutting system of the present invention, the first pressing controlling means may control the pressing means such that the pressing means moves along the scribing line while the first holding means and the pressing means oppose each other with the brittle substrate therebetween and while the scribing line forming means forms the scribing line on the first surface of the brittle substrate.

The pressing means is moved along the scribing line formed on a first surface of the brittle substrate while the first holding means and the pressing means oppose each other with a brittle substrate therebetween and while a scribing forming means forms a scribing line on the first surface of the brittle substrate. Therefore, a scribing step and a breaking step on the brittle substrate are approximately simultaneously performed. As a result, time of cutting step for the brittle substrate can be reduced.

According to a brittle substrate cutting system of the present invention, the scribing apparatus may include a scribing line forming means for forming the scribing line on the first surface of the brittle substrate while the first surface of the brittle substrate is held, and the breaking apparatus may further include a pressing means for pressing the second surface opposing the first surface of the brittle substrate.

According to a brittle substrate cutting system of the present invention, the pressing means is moved along the scribing line formed on the first surface of the brittle substrate while the scribing line forming means holds the first surface of the brittle substrate and while the pressing means holds the second surface of the brittle substrate. Therefore, the a pressing force is applied to the second surface of the brittle substrate along the scribing line, this second surface opposing the first surface of the brittle substrate on which the scribing line is formed. As a result, a bending moment is applied to the brittle substrate such that a vertical crack extending from the scribing line positively extends in the thickness direction of the substrate to cut the brittle substrate.

Furthermore, since the scribing line is formed, while the scribing forming means holds the first surface of the brittle substrate and the pressing means presses the second surface of the brittle substrate, the scribing step and the breaking step are approximately simultaneously performed. Accordingly, time of a cutting step for the brittle substrate is reduced.

According to a brittle substrate cutting system of the present invention, the brittle substrate may be a bonded substrate obtained by bonding substrates, the scribing apparatus may include a first scribing forming means for forming a first scribing line on a first surface of the bonded substrate and a second scribing line forming means for forming a second scribing line on a second surface of the bonded substrate opposing the first surface of the bonded substrate, and the breaking apparatus may break the bonded substrate along the first scribing line formed on the first surface of the bonded substrate by the first scribing line forming means and break the bonded substrate along the second scribing line formed on the second surface of the bonded substrate by the second scribing line forming means, and the first pressing controlling means may move a pressing force upon the second surface of the bonded substrate opposing the first surface of the bonded substrate along the scribing line while the first surface of the bonded substrate is held.

According to a brittle substrate cutting system of the present invention, a pressing force upon a second surface of the bonded substrate is moved along the scribed line formed on a first surface of the bonded substrate while the first surface of the bonded substrate is held, this second surface of the bonded substrate opposing the first surface of the bonded substrate. In this manner, while the pressing force is moved along the scribing line formed on the first surface of the bonded substrate, the pressing force is applied to the second surface of the bonded substrate, this second surface opposing the first surface of the bonded substrate. Therefore, a bending moment is applied to the bonded substrate such that a vertical crack extending from the scribing line extends in the thickness direction of the substrate to cut the bonded substrate.

According to a brittle substrate cutting system of the present invention, the breaking apparatus may include: a first bonded substrate pressing means for pressing the first surface of the bonded substrate; a second bonded substrate pressing means for pressing the second surface of the bonded substrate; a first bonded substrate holding means for holding the first surface of the bonded substrate; a second bonded substrate holding means for holding the second surface of the bonded substrate; a first controlling means for the pressing means for controlling the second bonded substrate pressing means such that the second bonded substrate pressing means moves along the first scribing line while the first bonded substrate holding means and the second bonded substrate holding means oppose each other with the bonded substrate therebetween; and a second controlling means for the pressing means for controlling the first bonded substrate pressing means such that the first bonded substrate pressing means moves along the second scribing line while the second bonded substrate holding means and the first bonded substrate holding means oppose each other with the bonded substrate therebetween.

According to a brittle substrate cutting system of the present invention, the pressing means is moved along the scribing line formed on the first surface of the brittle substrate while the holding means holds the first surface of the bonded substrate and while the pressing means presses the second surface of the bonded substrate. Furthermore, another pressing means is moved along the scribing line formed on the second surface of the brittle substrate while the another holding means holds the second surface of the bonded substrate and while the another pressing means presses the first surface of the bonded substrate. As a result, a bending moment is applied to the bonded substrate such that a vertical crack extending from the scribing line positively extends in the thickness direction of the substrate to cut the bonded substrate.

According to a brittle substrate cutting system of the present invention, the first controlling means for the pressing means may control the second bonded substrate pressing meanssuch that the second bondedsubstrate pressing means rolls along the first scribing line, and the second controlling means for the pressing means controls the first bonded substrate pressing means such that the first bonded substrate pressing means rolls along the second scribing line.

The controlling means readily moves the pressing means along the scribing line and another controlling means readily moves another pressing means along another scribing line.

According to a brittle substrate cutting system of the present invention, the first bonded substrate pressing means and the second bonded substrate pressing means may be rollers.

Since rollers are used as the pressing means and another pressing means, the controlling means and another controlling means readily rotate the pressing means and the another pressing means along the scribing line.

According to a brittle substrate cutting system of the present invention, the pressing means may be a conveyor.

Since conveyors are used as the pressing means and another pressing means, the controlling means and another controlling means readily rotate the pressing means and the another pressing means along the scribing line.

According to a brittle substrate cutting system of the present invention, the pressing means may be a bearing.

Since bearings are used as the pressing means and another pressing means, the controlling means and another controlling means readily rotate the pressing means and the another pressing means along the scribing line.

According to a brittle substrate cutting system of the present invention, a first groove section may be formed in the second bonded substrate pressing means such that the second banded substrate pressing means does not contact with a line on the second surface of the bonded substrate, the line opposing the first scribing line, and a second groove section may be formed in the first bonded substrate pressing means such that the first bonded substrate pressing means does not contact with a line on the first surface of the bonded substrate, the line opposing the second scribing line.

When the bonded substrate is cut along the scribing line, the pressing means holds both sides of the line on the surface of the bonded substrate so as not to contact with the line opposing the scribing line. Therefore, occurrence of chippings at the cut face portion is prevented during the cutting process.

According to a brittle substrate cutting system of the present invention, the breaking apparatus may further include a first controlling means for the holding means for controlling the first bonded substrate holding means such that the first bonded substrate holding means moves along the first scribing line while the first bonded substrate holding means and the second bonded substrate pressing means oppose each other with the bonded substrate therebetween, and a second controlling means for the holding means for controlling the second bonded substrate holding means such that the second bonded substrate holding means moves along the second scribing line while the second bonded substrate holding means and the first bonded substrate pressing means oppose each other with the bonded substrate therebetween.

The bonded substrate is cut without forming a plurality of starting points of cutting. As a result, a cut face is formed without having unevenness on the brittle substrate.

According to a brittle substrate cutting system of the present invention, the first controlling means for the holding means may control the first bonded substrate holding means such that the first bonded substrate holding means rolls along the first scribing line, and the second controlling means for the holding means may control the second bonded substrate holding means such that the second bonded substrate holding means rolls along the second scribing line.

The controlling means readily movesthe holding means along the scribing line, and another controlling means readily moves another holding means along another scribing line.

According to a brittle substrate cutting system of the present invention, the first bonded substrate holding means and the second bonded substrate holding means may be rollers.

Since rollers are used as the holding means and another holding means, the controlling means and another controlling means readily rotate the holding means and the another holding means along the scribing line.

According to a brittle substrate cutting system of the present invention, the first bonded substrate holding means and the second bonded substrate holding means may be conveyors.

Since conveyers are used as the holding means and another holding means, the controlling means and another controlling means readily rotate the holding means and the another holding means along the scribing line.

According to a brittle substrate cutting system of the present invention, the first bonded substrate holding means and the second bonded substrate holding means may be bearings.

Since bearings are used as the holding means and another holding means, the controlling means and another controlling means readily rotate the holding means and the another holding means along the scribing line.

According to a brittle substrate cutting system of the present invention, a third groove section may be formed in the first bonded substrate holding means such that the first bonded substrate holding means does not contact with the first scribing line, and a fourth groove section may be formed in the second bonded substrate holding means such that the second bonded substrate holding means does not contact with the second scribing line.

When the bonded substrate is cut along the scribing line, the pressing means holds both sides of the scribing line so as not to contact with the scribing line. Therefore, occurrence of chippings at the cut face portion is prevented during the cutting process.

According to a brittle substrate cutting system of the present invention, the width of the third groove section formed in the first bonded substrate holding means may be larger than that of the second bonded substrate pressing means, and the width of the fourth groove section formed in the second bonded substrate holding means may be larger than that of the first bonded substrate pressing means.

The bonded substrate is positively cut since a portion of the pressing means goes under the holding means, so that the bonded substrate is likely to bend.

According to a brittle substrate cutting system of the present invention, the first bonded substrate pressing means and the second substrate pressing means respectively may move in a first direction along the first scribing line and the second scribing line, and the brittle substrate cutting system may further include a third bonded substrate holding means and a fourth bonded substrate holding means respectively for holding the brittle substrate in the first direction from the first bonded substrate pressing means and the second bonded substrate pressing means, and the breaking apparatus may further include a third controlling means for the holding means for controlling the third bonded substrate holding means such that the third bonded substrate holding means moves on the first surface along the first scribing line while the third bonded substrate holding means holds the bonded substrate, and controlling the fourth bonded substrate holding means such that the fourth bonded substrate holding means moves on the second surface along the second scribing line while the fourth bonded substrate holding means holds the bonded substrate.

The holding means is moved along the scribing line while holding the uncut portions of the area on which the scribing line is formed, thereby preventing an unnecessary force being applied to the areas which are being pressed by the pressing means. As a result, chippings at the cut face portion formed on the bonded substrate can be prevented.

According to a brittle substrate cutting system of the present invention, the third controlling means for the holding means may control the third bonded substrate holding means such that the third bonded substrate holding means, the first bonded substrate holding means and the first bonded substrate pressing means move at a predetermined speed and the third controlling means for the holding means may control the fourth bonded substrate holding means such that the fourth bonded substrate holding means, the second bonded substrate holding means and the second bonded substrate pressing means move at the predetermined speed while the third bonded substrate holding means and the fourth bonded substrate holding means oppose each other with the bonded substrate therebetween.

Since the holding means and the pressing means are moved at the same speed, the bonded substrate is firmed held by the pressing means.

According to a brittle substrate cutting system of the present invention, the first bonded substrate pressing means may move in the first direction along the second scribing line, the second bonded substrate pressing means may move in the first direction along the first scribing line, and the brittle substrate cutting system may further include a fifth bonded substrate holding means and a sixth bonded substrate holding means respectively for holding the brittle substrate in a direction opposite to the first direction from the first bonded substrate pressing means and the second bonded substrate pressing means.

The holding means holds the cut portions of the area on which the scribing line is formed, thereby preventing an unnecessary force being applied to the areas which are being pressed by the pressing means. As a result, chippings at the cut face portion formed on the glass substrate can be prevented.

According to a brittle substrate cutting system of the present invention, the first controlling means for the pressing means may control the second bonded substrate pressing means such that the second bonded substrate pressing means moves along the first scribing line and the second controlling means for the pressing means may control the first bonded substrate pressing means such that the first bonded substrate pressing means may move along the second scribing line while the first bonded substrate holding means and the second bonded substrate pressing means oppose each other with the bonded substrate therebetween, the first scribing line forming means forms the first scribing line on the first surface of the bonded substrate, the second bonded substrate holding means and the first bonded substrate pressing means oppose each other with the bonded substrate therebetween and the second scribing line forming meansforms the second scribing line on the second surface of the bonded substrate.

The scribing step and the breaking step are approximately simultaneously performed. Accordingly, time of a cutting step for the bonded substrate is reduced.

A brittle substrate cutting method of the present invention includes the steps of (a) forming a scribing line on a first surface of a brittle substrate; and (b) breaking the brittle substrate along the scribing line, and the step (b) includes (b-1) the step: of moving a pressing force upon a second surface of the brittle substrate opposing the first surface of the brittle substrate along the scribing line while the first surface of the brittle substrate is held, thereby the above-described objective of the present invention being achieved.

According to a brittle substrate cutting method of the present invention, the step (b) may be performed by a breaking apparatus for breaking the brittle substrate along the scribing line, the breaking apparatus may include: a pressing means for pressing the second surface of the brittle substrate; and a first holding means for holding the first surface of the brittle substrate, and the step (b-1) may include the step of moving the pressing means along the scribing line while the first holding means and the pressing means oppose each other with the brittle substrate therebetween.

According to a brittle substrate cutting method of the present invention, the step (b-1) may include the step of controlling the pressing means such that the pressing means rolls along the scribing line.

According to a brittle substrate cutting method of the present invention, the pressing means may be a roller.

According to a brittle substrate cutting method of the present invention, the pressing means may be a conveyor.

According to a brittle substrate cutting method of the present invention, the pressing means may be a bearing.

According to a brittle substrate cutting method of the present invention, a groove section may be formed in the pressing means such that the pressing means does not contact with a line on the second surface of the brittle substrate, the line opposing the scribing line.

According to a brittle substrate cutting method of the present invention, the step (b) may further include the step of: (b-2) controlling the first holding means such that the first holding means moves along the scribing line while the first holding means and the pressing means oppose each other with the brittle substrate therebetween.

According to a brittle substrate cutting method of the present invention, the step (b-2) may include the step of controlling the first holding means such that the first holding means rolls along the scribing line.

According to a brittle substrate cutting method of the present invention, the holding means may be a roller.

According to a brittle substrate cutting method of the present invention, the holding means may be a conveyor.

According to a brittle substrate cutting method of the present invention, the holding means may be a bearing.

According to a brittle substrate cutting method of the present invention, a groove section may be formed in the first holding means such that the first holding means does not contact with the scribing line.

According to a brittle substrate cutting method of the present invention, the width of the groove section formed on the first holding means may be larger than that of the pressing means.

According to a brittle substrate cutting method of the present invention, the pressing means may move along the scribing line in a first direction and may further include a second holding means and a third holding means for holding the brittle substrate in the first direction from the pressing means, and the step (b) may further include the step of: (b-3) controlling the second holding means such that the second holding means moves on the first surface along the scribing line while the second holding means holds the brittle substrate, and controlling the third holding means such that the third holding means moves on the second surface along the scribing line while the third holding means holds the brittle substrate.

According to a brittle substrate cutting method of the present invention, the step (b-3) may include the step of controlling the second holding means such that the first holding means and the second holding means move at a predetermined speed, and controlling the third holding means such that the third holding means and the pressing means move at the predetermined speed while the second holding means and the third holding means oppose each other with the brittle substrate therebetween.

According to a brittle substrate cutting method of the present invention, the pressing means may move in a first direction along the scribing line and may further include a fourth holding means and a fifth holding means for holding the brittle substrate in a direction opposite to the first direction from the pressing means.

According to a brittle substrate cutting method of the present invention, the step (a) may include steps of: (a-1) irradiating a laser beam on the first surface of the brittle substrate; and (a-2) cooling the vicinity of the portions of the first surface of the brittle substrate where the laser beam is irradiated by the laser beam irradiating means.

According to a brittle substrate cutting method of the present invention, the step (a-2) may be performed by a cooling medium, and the cooling means is a cooling nozzle, and the cooling nozzle cools the vicinity of the portions where the laser beam is irradiated, by spraying a cooling medium on the first surface of the brittle substrate.

According to a brittle substrate cutting method of the present invention, wherein the step (a-1) may be performed by a laser beam irradiating means and may include the step of receiving at least one of the laser beam irradiated by the laser beam irradiating means and the medium sprayed by the cooling nozzle.

According to a brittle substrate cutting method of the present invention, the step of receiving at least one of the laser beam irradiated by the laser beam irradiating means and the medium sprayed by the cooling nozzle may be performed by a laser beam/cooling medium receiving section, and the laser beam/cooling medium receiving section may be movable separately from the pressing means.

According to a brittle substrate cutting method of the present invention, the cooling nozzle may be movable along the scribing line.

According to a brittle substrate cutting method of the present invention, the step (a) may further include the step of forming a notch at a starting position of forming the scribing line on the first surface of the brittle substrate.

According to a brittle substrate cutting method of the present invention, the step of forming a notch may be performed by a notch forming cutter mechanism, and the notch forming cutter mechanism may be integrally movable with the laser beam irradiating means and the cooling means.

According to a brittle substrate cutting method of the present invention, the step (a) may be performed by a scribing line forming means, and the scribing line forming means is a cutter.

According to a brittle substrate cutting method of the present invention, the cutter may be a disk-shaped cutter wheel tip, and an edge portion is formed in an outer circumferential edge of the cutter wheel tip.

According to a brittle substrate cutting method of the present invention, a plurality of recessed portions may be formed in a ridge-shaped section of the edge portion with a predetermined distance.

According to a brittle substrate cutting method of the present invention, the cutter may be movable separately from the pressing means.

According to a brittle substrate cutting method of the present invention, the step (b-1) may control the pressing means such that the pressing means moves along the scribing line while the first holding means and the pressing means oppose each other with the brittle substrate therebetween and while the scribing line forming means forms the scribing line on the first surface of the brittle substrate.

According to a brittle substrate cutting method of the present invention, the step (a) may further include the step of forming the scribing line on the first surface of the brittle substrate while the first surface of the brittle substrate is held, and the step (b) further may include the step of pressing a second surface opposing the first surface of the brittle substrate.

According to a brittle substrate cutting method of the present invention, the brittle substrate may be a bonded substrate obtained by bonding substrates, the scribing apparatus includes afirstscribing forming meansfor forming a first scribing line on a first surface of the bonded substrate and a second scribing line forming means for forming a second scribing line on a second surface of the bonded substrate opposing the first surface of the bonded substrate, and the step (b-1) may include the steps of: breaking the bonded substrate along the first scribing line formed on the first surface of the bonded substrate by the first scribing line forming means and breaking the bonded substrate along the second scribing line formed on the second surface of the bonded substrate by the second scribing line forming means, and moving a pressing force upon the second surface of the bonded substrate opposing the first surface of the bonded substrate along the scribing line while the first surface of the bonded substrate is held.

According to a brittle substrate cutting method of the present invention, the step (b) may be performed by a breaking apparatus for breaking the brittle substrate along the scribing line, the breaking apparatus may include: a first bonded substrate pressing means for pressing the first surface of the bonded substrate; a second bonded substrate pressing means for pressing the second surface of the bonded substrate; a first bonded substrate holding means for holding the first surface of the bonded substrate; and a second bonded substrate holding means for holding the second surface of the bonded substrate; and the step (b-1) may include the steps of: controlling the second bonded substrate pressing means such that the second bonded substrate pressing means moves along the first scribing line while the first bonded substrate holding means and the second bonded substrate holding means oppose each other with the bonded substrate therebetween; and controlling the first bonded substrate pressing means such that the first bonded substrate pressing means moves along the second scribing line while the second bonded substrate holding means and the first bonded substrate holding means oppose each other with the bonded substrate therebetween.

According to a brittle substrate cutting method of the present invention, the step (b-1) may include the steps of: controlling the second bonded substrate pressing means such that the second bonded substrate pressing means rolls along the first scribing line; and controlling the first bonded substrate pressing means such that the first bonded substrate pressing means rolls along the second scribing line.

According to a brittle substrate cutting method of the present invention, the first bonded substrate pressing means and the second bonded substrate pressing means may be rollers.

According to a brittle substrate cutting method of the present invention, the pressing means may be a conveyor.

According to a brittle substrate cutting method of the present invention, the pressing means may be a bearing.

According to a brittle substrate cutting method of the present invention, a first groove section may be formed in the second bonded substrate pressing means such that the second bonded substrate pressing means does not contact with a line on the second surface of the bonded substrate, the line opposing the first scribing line, and a second groove section is formed in the first bonded substrate pressing means such that the first bonded substrate pressing means does not contact with a line on the first surface of the bonded substrate, the line opposing the second scribing line.

According to a brittle substrate cutting method of the present invention, the step (b) may further include the steps of: (b-2) controlling the first bonded substrate holding means while the first bonded substrate holding means and the second bonded substrate pressing means oppose each other with the bonded substrate therebetween such that the first bonded substrate holding means moves along the first scribing line, and controlling the second bonded substrate holding meanswhile the second bonded substrate holding means and the first bonded substrate pressing means oppose each other with the bonded substrate therebetween such that the second bonded substrate holding means moves along the second scribing line.

According to a brittle substrate cutting method of the present invention, the step (b-2) may include the step of controlling the first bonded substrate holding means such that the first bonded substrate holding means rolls along the first scribing line, and controlling the second bonded substrate holding means such that the second bonded substrate holding means rolls along the second scribing line.

According to a brittle substrate cutting method of the present invention, the first bonded substrate holding means and the second bonded substrate holding means may be rollers.

According to a brittle substrate cutting method of the present invention, the first bonded substrate holding means and the second bonded substrate holding means may be conveyors.

According to a brittle substrate cutting method of the present invention, the first bonded substrate holding means and the second bonded substrate holding means may be bearings.

According to a brittle substrate cutting method of the present invention, a third groove section may be formed in the first bonded substrate holding means such that the first bonded substrate holding means does not contact with the first scribing line, and a fourth groove section may be formed in the second bonded substrate holding means such that the second bonded substrate holding means does not contact with the second scribing line.

According to a brittle substrate cutting method of the present invention, the width of the third groove section formed in the first bonded substrate holding means may be larger than that of the second bonded substrate pressing means, and the width of the fourth groove section formed in the second bonded substrate holding means may be larger than that of the first bonded substrate pressing means.

According to a brittle substrate cutting method of the present invention, the first bonded substrate pressing means and the second substrate pressing means respectively may move in a first direction along the first scribing line and the second scribing line, and the brittle substrate cutting method may further include the use of a third bonded substrate holding means and a fourth bonded substrate holding means respectively for holding the brittle substrate in the first direction from the first bonded substrate pressing means acid the second bonded substrate pressing means, and the step (b) may further include the step of: (b-3) controlling the third bonded substrate holding means such that the third bonded substrate holding means moves on the first surface along the first scribing line while the third bonded substrate holding means holds the bonded substrate and for controlling the fourth bonded substrate holding means such that the fourth bonded substrate holding means moves on the second surface along the second scribing line while the fourth bonded substrate holding means holds the bonded substrate.

According to a brittle substrate cutting method of the present invention, the step (b-3) may include the step of: controlling the third bonded substrate holding means such that the third bonded substrate holding means, the first bonded substrate holding means and the first bonded substrate pressing means move at a predetermined speed and the third controlling means for the holding means controls the fourth bonded substrate holding means such that the fourth bonded substrate holding means, the second bonded substrate holding means and the second bonded substrate pressing means move at the predetermined speed while the third bonded substrate holding means and the fourth bonded substrate holding means oppose each other with the bonded substrate therebetween.

According to a brittle substrate cutting method of the present invention, the first bonded substrate pressing means may move in the first direction along the second scribing line, the second bonded substrate pressing means moves in the first direction along the first scribing line, and the brittle substrate cutting method may further include the use of a fifth bonded substrate holding means and a sixth bonded substrate holding means respectively for holding the brittle substrate in a direction opposite to the first direction from the first bonded substrate pressing means and the second bonded substrate pressing means.

A brittle substrate cutting method according to the present invention may include the step of controlling the second bonded substrate pressing means such that the second bonded substrate pressing means moves along the first scribing line and controlling the first bonded substrate pressing means such that the first bonded substrate pressing means moves along the scribing line while the first bonded substrate holding means and the second bonded substrate pressing means oppose each other with the bonded substrate therebetween, the first scribing line forming means forms the first scribing line on the first surface of the bonded substrate, the second bonded substrate holding means and the first bonded substrate pressing means oppose each other with the bonded substrate therebetween and the second scribing line forming means forms the second scribing line on the second surface of the bonded substrate.

### BRIEF DESCRIPTION OF THE DRAWINGS

FIG. 1 is a perspective view schematically showing a structure of a cutting apparatus 100 according to Embodiment 1 of the present invention.

FIG. 2 is a front view showing a structure of a scribing unit 40 and a breaking unit 30.

FIG. 3 is a front view showing a structure of a pressing mechanism.

FIG. 4 is a cross-section view showing a substrate holding roller.

FIG. 5 is a cross-section view showing a pressing mechanism.

FIG. 5A is a perspective view showing a pressing conveyor mechanism 32a, which is another example for a pressing roller mechanism 32.

FIG. 6 is a view showing a state in which the center portion of a laser beam/cooling water receiving section 35 matches an optical axis of a laser beam irradiating optical system 43 and a nozzle section 42a of a cooling mechanism 42 is moved to a cooling water spraying position located above by an air cylinder 42b for moving upward/downward.

FIG. 7 is a view showing a state in which a breaking unit 30 and a scribing unit 40 oppose each other.

FIG. 8 is a view showing a state in which flat side edge portions in the width direction on both sides of the substrate holding roller 45a with an outer circumferential surface thereof recessed in a V-shape are pressed upon both sides of the scribing line formed on the glass substrate 90.

FIG. 9 is a view showing another example for the cutting apparatus 100.

FIG. 10 is a view schematically showing a breaking unit 30 and a scribing unit 40 according to Embodiment 2 of the present invention.

FIG. 11 is a view showing that a glass substrate 90 is cut along a scribing line when a pressing roller 32a is sequentially pressed upon both side portions of the scribing line of the glass substrate 90 which is held by a substrate holding roller 45a.

FIG. 12 is a perspective view showing a cutting apparatus according to Embodiment 3 of the present invention.

FIG. 13 is a front view showing a breaking unit 30 and a scribing unit 40 included in the cutting apparatus according to Embodiment 3 of the present invention.

FIG. 14 is a view showing a state in which an optical axis of a laser beam irradiating optical system 43 matches a notch and the center portion of a laser beam/cooling water receiving section 35 matches the optical axis of the laser beam irradiating optical system 43.

FIG. 15 is a front view showing a breaking unit 30 and a scribing unit 40 provided in the cutting apparatus according to Embodiment 4 of the present invention.

FIG. 16 is a view showing a state in which a pressing roller 32a and a substrate holding roller 45a oppose each other with a glass substrate 90 therebetween.

FIG. 17 is a front view showing a structure of a breaking unit 30 and a scribing unit 40 provided in a cutting apparatus according to Embodiment 5 of the present invention.

FIG. 18 is a view schematically showing a structure of a cutting apparatus according to Embodiment 7.

FIG. 19 is a view for illustrating an operation of the cutting apparatus according to Embodiment 7.

FIG. 20 is a flow chart showing a procedure for cutting a substrate according to a number of embodiments of the present invention.

FIG. 21 is a front view showing a structure of breaking units 30 and a scribing unit 40 provided in a cutting apparatus according to Embodiment 8 of the present invention.

### BEST MODE FOR CARRYING OUT THE INVENTION

Hereinafter, embodiments of the present invention will be described in detail with reference to the drawings.

### EMBODIMENT 1

1. Cutting Apparatus

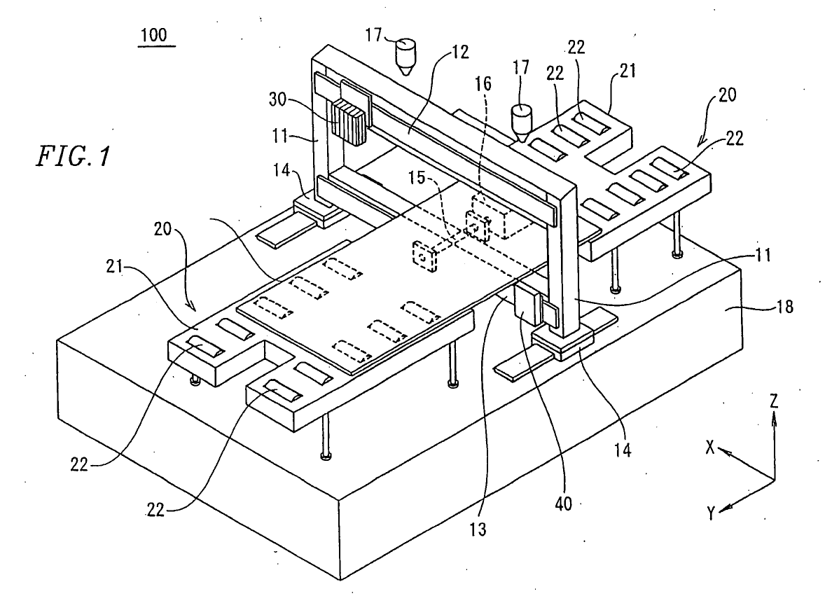

FIG. 1 is a perspective view schematically showing a structure of a cutting apparatus 100 according to Embodiment 1 of the present invention.

The cutting apparatus 100 is, for example, used in order to cut a glass substrate 90 into a predetermined size. The glass substrate 90 is a brittle substructure which is used for a liquid crystal display panel. The cutting apparatus 100 includes a base 18 and a pair of base supporting mechanisms 20 provided on the base 18. The glass substrate 90 to be cut is mounted on the pair of the base supporting mechanisms 20 in a horizontal state. The glass substrate 90 is supported between the pair of the substrate supporting mechanisms 20 in a bridged state.

The cutting apparatus 100 further includes a supporting table 21 and a plurality of transporting rollers 22. The pair of substrate supporting mechanisms 20 includes the supporting table 21 arranged on the base 18 in a horizontal state and the plurality of transporting rollers 22 rotatably arranged at the upper portion of the supporting table 21.

For example, a plurality of adsorbing holes (not shown) is formed in at least one of the pair of the supporting tables 21. An adsorbing means (e.g., a vacuum pump or adsorbing motor which is not shown) adsorbs the glass substrate 90 through the plurality of adsorbing holes. The glass substrate 90 is adsorbed onto the supporting table 21 in this manner. Therefore, the glass substrate 90 is fixed on at least one of the pair of supporting tables 21.

The plurality of transporting rollers 22 is arranged so as to be in plurality of columns (two columns in FIG. 1). The plurality of columns is parallel to each other. Each of the plurality of transporting rollers in each column is arranged with a predetermined distance therebetween. The plurality of transporting rollers 22 are moved upward and downward by an upward/downward means (not shown). The plurality of transporting rollers 22 are moved upward, so that upper portions of the plurality of transporting rollers are projected above an upper surface of the supporting table 21. When the upper portions of the plurality of transporting rollers 22 are projected above the upper surface of the supporting table 21, the plurality of transporting rollers 22 are rotated, so that the glass substrate 90 is horizontally transported from the supporting table 21 of one of the pair of the substrate supporting mechanisms 20 to the supporting table 21 of the other of the pair of the substrate supporting mechanisms 20. The plurality of transporting rollers 22 are moved downward, so that the upper portions of the plurality of transporting rollers 22 are lowered below the upper surface of the supporting table 21.

The cutting apparatus 100 further includes a breaking unit 30, a scribing unit 40, an upper guide rail 12, a lower guide rail 13, a pair of supporting posts 11 and a pair of sliders. The breaking unit 30 and the scribing unit 40 are provided between the pair of substrate supporting mechanisms 20 to be used for cutting the glass substrate 90. The breaking unit 30 and the scribing unit 40 are respectively slidably attached to the upper guide rail 12 and the lower guide rail 13. The structures of the breaking unit 30 and the scribing unit 40 will be described later in detail with reference to the accompanying drawings.

The upper guide rail 12 and the lower guide rail 13 are arranged along an X direction orthogonal to a transporting direction of the glass substrate which is transported by the pair of substrate supporting mechanisms 20. Each end portion of the upper guide rail 12 is bridged in a horizontal state between upper portions of the pair of supporting posts 11 which are provided on the base 18 in a vertical state. Each end portion of the lower guide rail 13 is bridged in a horizontal state between lower portions of the pair of the supporting posts 11. The breaking unit 30 and the scribing unit 40 respectively slide along the upper guide rail 12 and the lower guide rail 13 powered by a linear motor mechanism, for example.

Each of the pair of the supporting posts 11 is provided on an upper surface of the base 18. Each of the pair of the supporting posts 11 is slidable along sliders 14 in a direction orthogonal to a longitudinal direction of the upper guide rail 12 and the lower guide rail 13. Each of the pair of the supporting posts 11 is integrated with the upper guide rail 12 and the lower guide rail 13. When each of the pair of supporting posts 11 supported by the sliders 14 slides, the upper guide rail 12 and the lower guide rail 11 integrally slide.

The cutting apparatus 100 further includes a driving section for linear interpolation. The driving section for linear interpolation is provided in a longitudinal direction below a center portion of the lower guide rail 13 arranged between lower portions of each of the pair of the supporting posts 11. The driving section for linear interpolation includes a ball screw 15 along a Y direction which is orthogonal to the longitudinal direction of the lower guide rail 13. The ball screw 15 rotates in forward and backward directions by a motor 16. In the ball screw 15, a ball nut (not shown) is attached to the center portion of the lower guide rail 13 in the longitudinal direction. The ball nut engages with the ball screw 15. When the ball screw 15 is rotated by the motor 16, a force along the transporting direction of the glass substrate 90 is applied to the lower guide rail 13. As a result, the pair of the supporting posts 11 supported to be slidably by the sliders 14 slides in the Y direction which is orthogonal to the longitudinal directions of the upper guide rail 12 and the lower guide rail 13.

The cutting apparatus 100 further includes a pair of positioning cameras 17. The pair of positioning cameras 17 is provided in the vicinity of the upper guide rail 12 with an appropriate distance therebetween in the longitudinal direction of the upper guide rail 12. The pair of positioning cameras 17 captures an alignment mark provided on the glass substrate 90 when the glass substrate 90 is positioned.

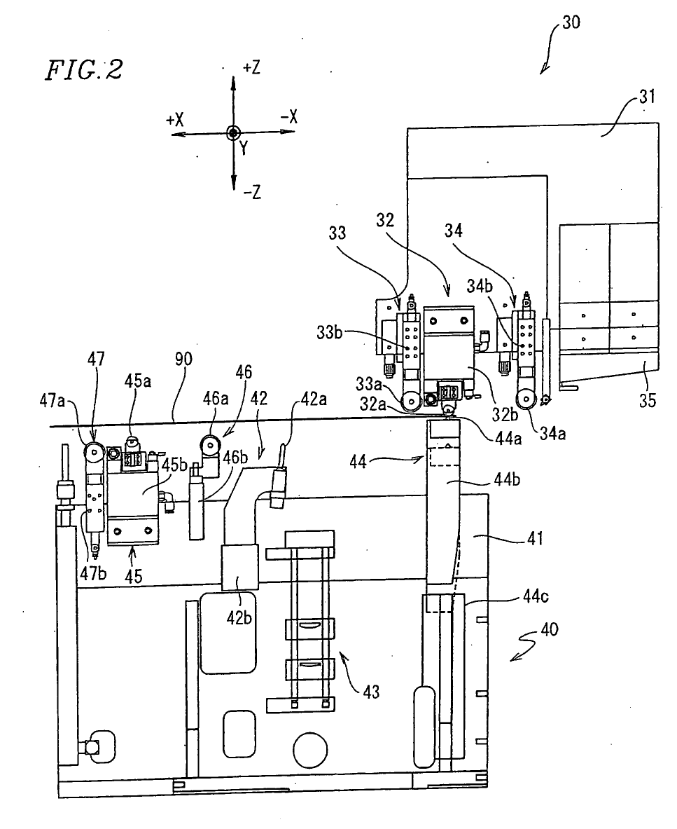

FIG. 2 is a front view showing a structure of the scribing unit 40 and the breaking unit 30.

Hereafter, the structure of the scribing unit 40 will be described in detail in reference to FIG. 2.

The scribing unit 40 includes a unit body 41, a cooling mechanism 42 for spraying a cooling medium upward and a laser beam irradiating optical system 43 irradiating a laser beam upward.

The unit body 41 is attached to the lower guide rail 13 so as to be slidable. The cooling mechanism 42 is provided approximately at a center portion of the unit body 41. The laser beam irradiating optical system 43 is provided at one side of the cooling mechanism 42.

The laser beam irradiating optical system 43 irradiates a laser beam onto the glass substrate 90 supported by the pair of the substrate supporting mechanisms 20 in a bridged state. A notch forming cutter mechanism 44 is provided on the opposite side of the cooling mechanism 42 with respect to the laser beam irradiating optical system 43.

The cooling mechanism 42 sprays the cooling medium (e.g., a cooling liquid) in the vicinity of the portions where the laser beam is irradiated such that the portions irradiated by the laser beam are cooled. The cooling mechanism 42 includes a nozzle section 42a for spraying the cooling medium upward and an air cylinder 42b. The air cylinder 42b moves the nozzle section 42a between a spraying position and a waiting position. The spraying position is a position adjacent to the glass substrates 90 where the nozzle section 42a sprays the cooling medium. The waiting position is a position located at a distance below the glass substrate 90.

A cooling medium is not limited to a cooling liquid as long as the cooling medium cools portions irradiated by the laser beam. The cooling medium includes, for example, at least one of vapor and liquid. The vapor includes, for example, compressed air, helium and argon. The liquid includes, for example, water and liquefied helium. The cooling medium is, for example, a combination of these vapors and liquids.

A laser beam is irradiated on the glass substrate 90, and the vicinity of the portions where the laser beam is irradiated is cooled such that a scribing line with a vertical crack generated therein is formed. Therefore, a stress distortion does not remain in an edge of a cut face. As a result, the cut face portion which is formed on the glass substrate 90 can be prevented from being chipped when the cut brittle substrate is transported to a different apparatus from the cutting apparatus 100, the different apparatus being used for a step subsequent to cutting the glass substrate 90.

When the cooling medium is sprayed onto the glass substrate 90 by the cooling nozzle, a predetermined area of the glass substrate 90 is thoroughly cooled.

The notch forming cutter mechanism 44 forms a notch as a trigger for forming a vertical crack along a line to be scribed of the glass substrate 90, this notch being formed at a starting position of scribing for the glass substrate 90. The notch forming cutter mechanism 44 includes an edge portion 44a, a bracket 44b and an air cylinder 44c for moving the edge portion 44a upward/downward. The edge portion 44a is arranged along a sliding direction of the scribing unit 40. The edge portion 44a is attached to an upper edge portion of the bracket 44b with a ridge facing upward. The edge portion 44a is moved upward/downward by the air cylinder 44c for moving upward/downward provided in the unit body 41.

In scribing unit 40, a substrate holding roller mechanism 45, a first auxiliary roller mechanism 46 and a second auxiliary roller mechanism 47 are provided on the opposite side of the laser beam irradiating optical system 43 with respect to the cooling mechanism 42. The first auxiliary roller mechanism 46 is provided between the substrate holding roller mechanism 45 and the cooling mechanism 42. The second auxiliary roller mechanism 47 is provided on the opposite side of the first auxiliary roller mechanism 46 with respect to the substrate holding roller mechanism 45. The substrate holding roller mechanism 45 and the second auxiliary roller mechanism 47 are attached to the unit body 41.

The substrate holding roller mechanism 45 includes a roller holder, a substrate holding roller 45a and a head section 45b. The substrate holding roller mechanism 45, for example, has a similar structure to that of a pressing roller mechanism 32 which will be described later.

The substrate holding roller 45a is attached to the roller holder as to be rotatable. An axis direction of the substrate holding roller 45a is a Y direction which is orthogonal to a sliding direction (X direction) of the scribing unit 40. The structure of the substrate holding roller 45a will be described in detail later with reference to the accompanying drawings. The head section 45b is driven so as to move upward/downward by a motor (not shown).

The first auxiliary roller mechanism 46 includes a first auxiliary roller 46a and an air cylinder 46b for moving upward/downward. The first auxiliary roller 46a is rotatably attached to an upper end portion of the air cylinder 46b for moving upward/downward attached to the unit body 41. An axis direction of the first auxiliary roller 46a is a X direction which is orthogonal to a sliding direction (X direction) of the scribing unit 40.

The second auxiliary roller mechanism 47 includes a second auxiliary roller 47a and an air cylinder 47b for moving upward/downward. The second auxiliary roller 47a is rotatably attached to an upper edge portion of the air cylinder 47b for moving upward/downward. An axis direction of the second auxiliary roller 47a is a Y direction which is orthogonal to a sliding direction (X direction) of the scribing unit 40. The second auxiliary roller 47a is arranged adjacent to the substrate holding roller 45a. The first auxiliary roller 46a is arranged at a distance form the substrate holding roller 45a which is further than the distance between the substrate holding roller 45a and the second auxiliary roller 47a.

Hereafter, the structure of the breaking unit 30 will be described in detail with reference to FIG. 2.

The breaking unit 30 is provided on the upper guide rail 12. The breaking unit 30 includes a breaking unit body 31, a pressing roller mechanism 32, a first auxiliary roller mechanism 33 on the pressing side and a second auxiliary roller mechanism 34 on the pressing side.

The breaking unit body 31 is slidable with respect to the upper guide rail 12. The pressing roller mechanism 32, the first auxiliary roller mechanism 33 on the pressing side and the second auxiliary roller mechanism 34 on the pressing side are attached to the breaking unit body 31. The first auxiliary roller mechanism 33 on the pressing side is provided on a side of the pressing roller mechanism 32. The second auxiliary roller mechanism 34 on the pressing side is provided on an opposite side of the first auxiliary roller mechanism 33 on the pressing side with respect to the pressing roller mechanism 32.

When the pressing roller mechanism 32 moves to a position which opposes the substrate holding roller mechanism 45, the first auxiliary roller mechanism 33 on the pressing side is arranged at a position which opposes the second auxiliary roller mechanism 47 and the second auxiliary roller mechanism 34 on the pressing side is arranged at a position which opposes the first auxiliary roller mechanism 46. The structure of the pressing roller mechanism 32 will be described later in detail with reference to the accompanying drawings.

The first auxiliary roller mechanism 33 on the pressing side includes a first auxiliary roller 33a on the pressing side and an air cylinder 33b. The first auxiliary roller 33a on the pressing side is rotatably attached to a lower edge portion of the air cylinder 33b. The first auxiliary roller 33a on the pressing side opposes the second auxiliary roller 47a when the glass substrate 90 is broken.

The second auxiliary roller mechanism 34 on the pressing side includes a second auxiliary roller 34a on the pressing side and an air cylinder 34b. The second auxiliary roller 34a on the pressing side is rotatably attached to a lower edge portion of the air cylinder 34b. The second auxiliary roller 34a on the pressing side opposes the first auxiliary roller 46a when the glass substrate 90 is broken.

The breaking unit 30 further includes a laser beam/cooling water receiving section 35. The laser beam/cooling water receiving section 35 receives a laser beam irradiated from a laser beam irradiating optical system 43 and cooling water sprayed from the cooling mechanism 42 on the opposite side of the first auxiliary roller mechanism 33 with respect to the pressing roller mechanism 32.

In Embodiment 1 of present invention, the breaking unit 30 is attached to the upper guide rail 12 so as to be slidable and the scribing unit 40 is attached to the lower guide rail 13 so as to be slidable. However, the structure of the cutting apparatus 100 is not limited to this. The breaking unit 30 may be attached to the lower guide rail 13 and the scribing unit 40 may be attached to the upper guide rail 12.

According to the brittle substrate cutting system (cutting apparatus 100) of the present invention, a pressing means (pressing mechanism) moves along the scribing line formed on the first surface of the brittle substrate while a first holding means (holding mechanism) holds a first surface of the brittle substrate (glass substrate 90) and the pressing means presses a second surface of the brittle substrate. Therefore, a pressing force is applied along the scribing line of the second surface of the brittle substrate, this second surface opposing the first surface of the brittle substrate on which the scribing line is formed. As a result, a bending moment is applied to the brittle substrate such that a vertical crack extending from the scribing line positively extends in the thickness direction of the substrate to out the brittle substrate.

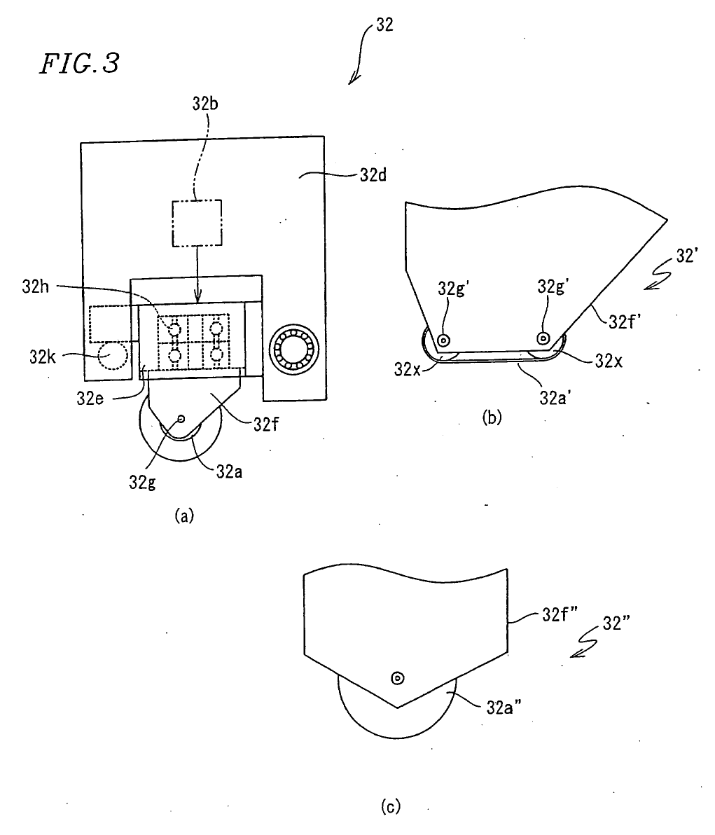

FIG. 3 is a front view showing a structure of the pressing mechanism.

FIG. 3(a) is a front view showing the pressing roller mechanism 32.

The pressing roller mechanism 32 includes a pressing roller 32a, an air cylinder 32b, a head section 32d, a sliding block 32e, a roller holder 32f, a supporting axis 32g, a bearing 32h and a stopper 32k.

The sliding block 32e is rotatably attached to the head section 32d. An energizing force is applied to the sliding block 32e by the air cylinder 32b which is provided in the head section 32d. The roller holder 32f is attached to the sliding block 32e so as to be rotatable around the vertical axis bar the bearing 32h.

The roller holder 32f is projacted below the sliding block 32e. The supporting axis 32g is provided on a lower edge portion of the roller holder 32f in a horizontal state.

The pressing roller 32a is provided on the supporting axis 32g so as to be rotatable. The pressing roller 32a opposes the substrate holding roller 45a when the glass substrate 90 is broken.

The stopper 32k is provided in the head section 32d. The stopper 32k detects a height of the head section 32d when the pressing roller contacts the glass substrate 90. The head section 32d is moved downward by a motor (not shown) of the pressing roller mechanism. When the pressing roller 32a contacts an upper surface of the glass substrate 90 with a predetermined force, micro current is flowed between the stopper 32k and the sliding block. The stopper 32k detects a change from a state in which the sliding block 32e and the stopper 32k are in contact to a state in which the sliding block 32e and the stopper 32k are separated. The stopper 32k also functions as a stopper for a rotating operation of the sliding block 32e.

When the change in state is detected, the state in which the sliding block 32e and the stopper 32k are in contact to the state in which the sliding block 32e and the stopper 32k are separated, a position of the head section 32d in a Z direction is calculated by a controller. The controller drives a motor such that the motor moves the head section 32d upward/downward. For example, a position (zero point position) in a vertical direction (Z direction) of the head section 32d with respect to a surface of the glass substrate 90 is calculated when the pressing roller 32a contacts the
glass substrate 90. An amount (distance) which the pressing roller 32a is pressed into the glass substrate is set based on the zero point position.

The structure of the substrate holding roller mechanism 45 is similar to that of the pressing roller mechanism 32 except that the substrate holding roller mechanism 45 is inverted in a vertical direction.

When a pressing means (e.g., pressing roller mechanism 32) rolls along the scribing line, the pressing means is readily moved along the scribing line.

When a pressing means is a roller, the pressing means is readily moved along the scribing line.

FIG. 3(b) shows a pressing conveyor mechanism 32′, which is another example for the pressing mechanism 32. The pressing conveyor mechanism 32′ includes a pressing conveyor 32a′, an air cylinder 32b, a head section 32d, sliding block 32e, a conveyor holder 32f, two supporting axes 32g′, a bearing 32h and a stopper 32k The structure of the pressing conveyor mechanism 32′ is the same as that of the pressing roller mechanism 32 except that the pressing conveyor 32′ and the conveyor holder 32f′ are included in the pressing conveyor mechanism 32′ instead of the pressing roller 32a instead of the roller holder 32f.

In FIG. 3(b), the same components as those in FIG. 3(a) are denoted by the same reference numerals, and the description thereof will be omitted.

The pressing means readily rolls along the scribing line since a conveyor is used as a pressing means.

FIG. 3(c) shows a pressing bearing mechanism 32″, which is another example for the pressing roller mechanism 32.

The pressing bearing mechanism 32″ includes a pair of pressing bearings 32x, an air cylinder 32b, a head section 32d, a sliding block 32e, a holder 32f″, a supporting axis 32g″, a bearing 32h and a stopper 32k. The structure of the pressing bearing mechanism 32″ is the same as that of the pressing roller mechanism 32 except that the pressing means 32a″ instead of the pressing roller 32a and the holder 32f′ instead of the roller holder 32f are included in the pressing bearing mechanism 32″.

In FIG. 3(c), the same components as those in FIG. 3(a) are denoted by the same reference numerals, and the description thereof will be omitted.

The pressing means readily rolls along the scribing line since a bearing is used as a pressing means.

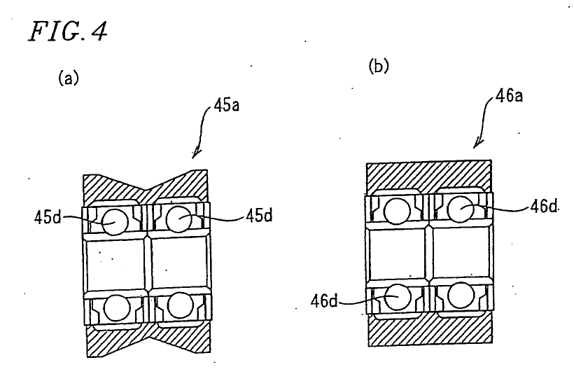

FIG. 4 is a cross-section view of a holding mechanism.

FIG. 4(a) is a cross-section view of a substrate holding roller 45a.

An outer circumferential surface of the substrate holding roller 45a is formed in a V-shape with the center portion in the width direction recessed except that side edge portions of both sides in the width direction are not recessed but flat. The dimension in the width direction of the substrate holding roller 45a is in a range of about 8 mm to about 24 mm. The substrate holding roller 45a holds portions of both sides of the scribing line by bridging the scribing line, these portions being distant about 4 mm to 12 mm from the scribe line.

The substrate holding roller 45a is attached to the supporting axis by the pair of the bearing 45d, this supporting axis being arranged in a direction orthogonal to the sliding direction of the scribing unit 40. Each of inner circular portions of the pair of the bearings 45d is respectively projected outside from each end face of the substrate holding roller 45a. As a result, the supporting axis which is attached to the substrate holding roller 45a is readily detachable from the roller holder.

The substrate holding roller 45a is formed of polyacetals, polyurethane rubber (rubber hardness Hs 20° to 90°), etc.

FIG. 4(b) is a cross-section view of a first roller auxiliary roller 46a.

An outer circumferential surface of the first auxiliary roller 46a is formed flat. The first auxiliary roller 46a is attached to the supporting axis by the pair of the bearings 46d, this supporting axis being arranged in a direction (Y direction) orthogonal to the sliding direction (x direction) of the scribing unit 40. The dimension in the width direction of the first auxiliary roller 46a is approximately the same as the dimension in the width direction of the substrate holding roller 45a. Each of inner circular portions of the pair of the bearings 46d is respectively projected outside from each end face of the first auxiliary roller 46a. As a result, the supporting axis is readily detachable from the roller holder.

The second auxiliary roller 47a, the first auxiliary roller on the pressing side 33a and the second auxiliary roller on the pressing side 34a, for example, also have the same structure as that of the first auxiliary roller 46a.

The first holding means (holding mechanism) moves (rolls) to sequentially cut the brittle substrate from one end face of the brittle substrate to the other end face of the brittle substrate while the first holding means and the pressing means (pressing mechanism) oppose to each other with brittle substrate therebetween. Therefore, the brittle substrate is cut without forming a plurality of starting points of cutting. As a result, a cut face is formed without having unevenness on the brittle substrate.

In the case where a roller, a conveyor or a bearing is used as a first holding means (holding mechanism), the first holding means readily rolls along the scribing line.

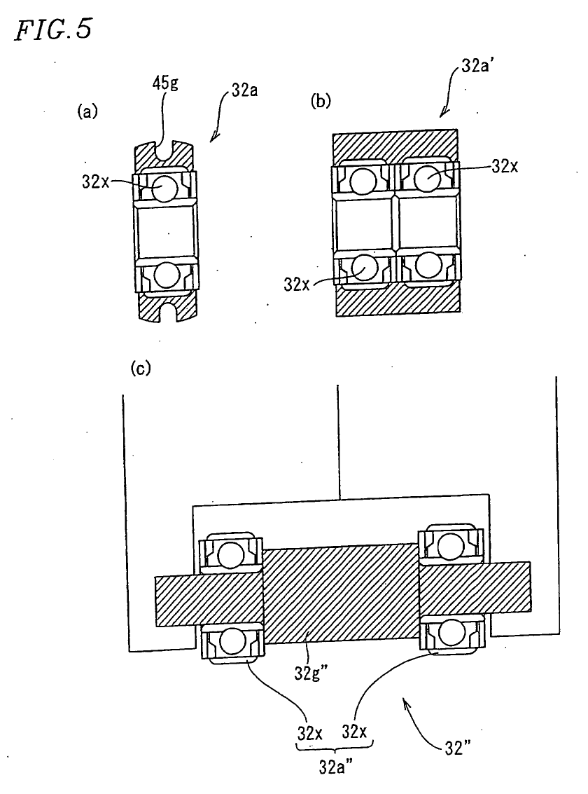

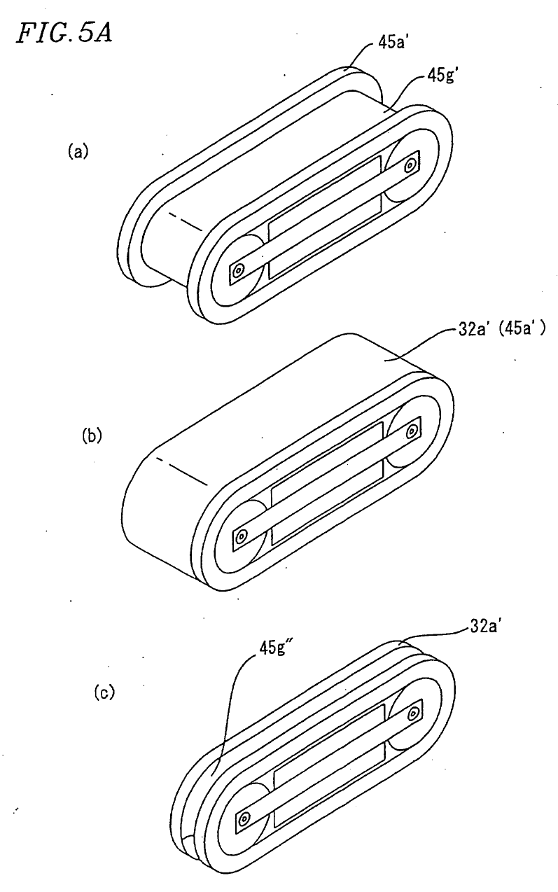

FIG. 5 is a cross-section view of the pressing mechanism.

FIG. 5(a) is a cross-section view of the pressing roller 33a.

The center portion of the outer circumference surface of the pressing roller 32a in the width direction is projected in an arc. An U-shaped groove section 45g is formed in the center portion of the outer circumference surface in the width direction. The dimension of the groove section 45g in the width direction is in a range of about 2 mm to 6 mm. The outer circumference surface of the pressing roller 32a presses a portion which is about 1 mm to 3 mm distant from the scribing line.

In this manner, the groove section 45g is formed in the pressing roller 32a such that the pressing roller 32a does not contact with a line on the surface on which the scribing line is not formed, this line opposing the scribing line.

The pressing roller 32a is rotatably attached to the supporting axis 32g (see FIG. 3) by one of the bearings 32x, this supporting axis being arranged in a direction (Y direction) orthogonal to the sliding direction (X direction) of the breaking unit 30. Accordingly, the length of the pressing roller 32a in the width direction is about one half of that of the substrate holding roller 45a and respective auxiliary rollers 46a, 47a, 33a. The inner circular portions of the bearing 32x are also respectively protruded outside from each end face of the substrate holding roller 45a. Therefore, the supporting axis 32g is readily detachable from the roller holder 32f (see FIG. 3).

The pressing roller 32a is formed of polyacetals, polyurethane rubber (rubber hardness Hs 20° to 900), etc. When the glass substrate 90 is cut, the pressing roller 32a opposes the substrate holding roller 45a. In such a case, the center line of the pressing roller 32a in the width direction matches the center line of the substrate holding roller 45a in the width direction.

The brittle substrate is expanded by the pressing roller 32a and the substrate holding roller such that areas on both sides of the scribing line formed on the substrate are separated from each other. Due to this, a vertical crack which is generated when the scribing line is formed is readily extended in the thickness direction of the brittle substrate.

FIG. 5(b) is a cross-section view of a pressing conveyor mechanism 32′, which is another example for the pressing mechanism 32.

An outer circumferential surface of the pressing conveyor mechanism 32′ is formed flat, which corresponds to the conveyor shown in FIG. 5A(b). The pair of the bearings 32x is supported within a conveyor holder by the two supporting axes 32g′ (see FIG. 3(b)). The pressing conveyor 32a′ is provided along the sliding direction (X direction) of the breaking unit 30 so as to be movable in a circle.

FIG. 5(c ) is a cross-view of a pressing bearing mechanism 32″, which is another example for the pressing mechanism 32.

The pressing bearing mechanism 32″ includes a supporting axis 32g″ and a pressing means 32a″.

The supporting axis 32g″ is elastic. The supporting axis 32g″ includes, for example, at least one of an engineering plastic and an engineering rubber. The outer diameters of the two side portions of the supporting axis 32g″ are smaller than the outer diameter of the center portion of the supporting axis 32g″.

The pressing means 32a″ includes two pressing bearings 32x. Each of the two pressing bearings 32x is inserted by being pressed into each of both side portions of the supporting axis 32g″.

The supporting axis 32g″ is elastic. Therefore, when both sides of the scribing line formed on the brittle substrate is pressed by the pressing means 32a″, the pressing bearing 32x can expand the areas on both sides of the scribing line such that areas on both sides of the scribing line formed on the brittle substrate are separated from each other. As a result, a vertical crack which is formed at the time when the scribing line is formed is readily extended in the thickness direction of the brittle substrate.

The pressing bearing mechanism 32″ can be used as the first holding means (holding mechanism). When the pressing bearing mechanism 32″ is used as the first holding means (holding mechanism), the two pressing bearings 32x function as the two holding bearings 32x. When the distance between the pair of the holding bearings 32x is larger than the width of the pressing means, the brittle substrate is more readily cut since the pressing means goes under the holding means, so that the pressed portion bends.

FIG. 5A(a) shows a holding conveyor 45a′. The holding conveyor 45a′ functions as a conveyor for the first holding means (holding mechanism). The holding conveyor 45a′ is provided so as to be movable in a circle along the sliding direction (X direction) of the scribing unit 40. In the holding conveyor 45a′, the groove section 45g′ is formed such that the holding conveyor 45a′ does not contact with the scribing line.

The holding conveyor 45a′ can expand areas on both sides of the scribing line such that areas on both sides of the scribing line formed on the substrate are separated from each other. As a result, a vertical crack which is formed at the time when the scribing line is formed readily extends in the thickness direction of the brittle substrate.

FIG. 5A(b) is a perspective view showing a pressing conveyor mechanism 32′, which is another example for the pressing mechanism 32. An outer circumference of the pressing conveyor mechanism 32′ is formed flat. The pressing conveyor 32a′ can be used as the holding conveyor 45a′.

FIG. 5A(c) is a perspective view showing a pressing conveyor mechanism 33a′, which is another example for the pressing mechanism 32. The pressing conveyor mechanism 32a′ is provided so as to be movable in a circle along the sliding direction (X direction) of the scribing unit 40. The groove section 45g″ is formed in the pressing conveyor mechanism 32a′ such that the pressing conveyor mechanism 32a′ does not contact with a line on the surface on which the scribing line is not formed, this line opposing the scribing line.

The pressing conveyor mechanism 32a′ can expand areas on both sides of the scribing line such that areas on both sides of the scribing line formed on the substrate are separated from each other. As a result, a vertical crack which is formed at the time when the scribing line is formed readily extends in the thickness direction of the brittle substrate.

When the pressing conveyor 32a′ shown in FIG. 5A(c) is used as a pressing means, the holding conveyor mechanism 45a′ shown in FIG. 5A(a) is used as a first holding means, and the groove section 45g′ of the first holding means is wider than that of the pressing means, the brittle substrate is more readily is cut since the pressing means goes under the first holding means to bend the pressed portion.

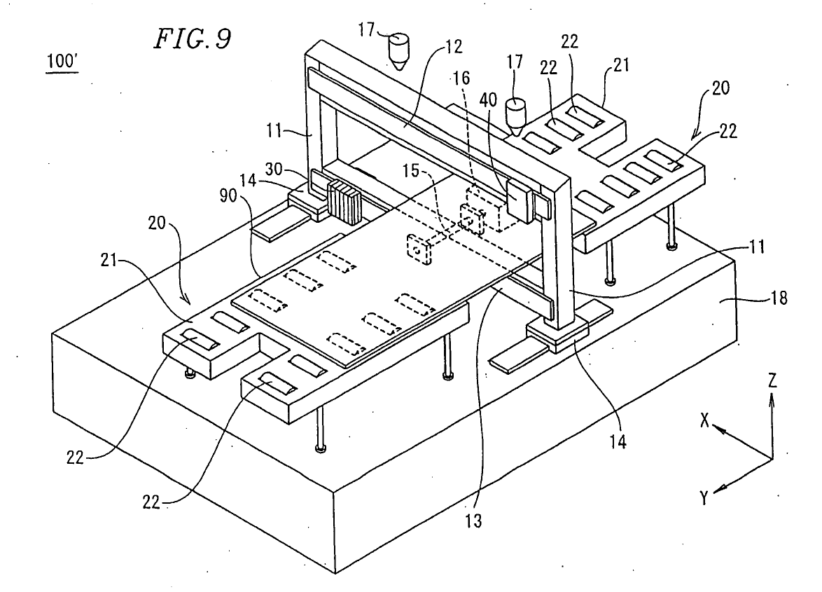

FIG. 9 is a perspective view schematically showing a structure, which is another example for the cutting apparatus 100.

In a cutting apparatus 100′ which is another example of the cutting apparatus 100, the breaking unit 30 is attached to the lower guide rail 13 so as to be slidable and the scribing unit 40 is attached to the upper guide rail 12 so as to be slidable.

According to a brittle substrate cutting system (cutting apparatus 100 and cutting apparatus 100′) of the present invention, a pressing force upon a second surface of the brittle substrate is moved along the scribed line formed on a first surface of the brittle substrate while the first surface of the brittle substrate (glass substrate 90) is held, this second surface of the brittle substrate opposing the first surface of the brittle substrate. In this manner, while the pressing force is moved along the scribing line formed on the first surface of the brittle substrate, the pressing force is applied to the second surface of the brittle substrate, this second surface opposing the first surface of the brittle substrate. Therefore, a bending moment is applied to the brittle substrate such that a vertical crack extending from the scribing line extends in the thickness direction of the substrate to cut the brittle substrate.

According to the cutting apparatus of the present invention, the glass substrate 90 on which the scribing line is formed is positively cut along the scribing line. Moreover, a working efficiency improves since the glass substrate 90 is cut immediately subsequent to the formation of the scribing line. Furthermore, unnecessary force is not applied to a scribe line S which is not cut when the glass substrate 90 is cut. There is no possibility that chippings occur at the end face of the cut glass substrate since the cut glass substrates 90 do not bend.

2. Substrate Cutting Method

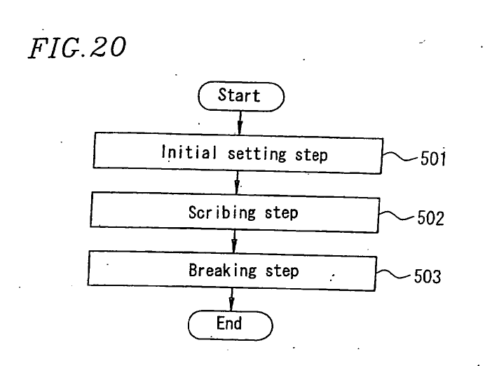

FIG. 20 shows a procedure of cutting a substrate according to the embodiments of the present invention.

Hereafter, the procedure of cutting the glass substrate 90 by the cutting apparatus 100 will be described in step by step.

The procedure of cutting the glass substrate 90 by the cutting apparatus 100 includes a scribing step and a breaking step. An initial setting step is performed as appropriate.

Step 501: The initial setting step is performed. The initial setting step is a step of setting an initial state for the substrate cutting apparatus 100 prior to the start of the scribing step.

When the initial setting step is completed, the process proceeds to Step 502.

Step 502: The scribing step is performed. The scribing step is a step of forming a scribing line on the glass substrate 90. The scribing step will be described later in detail.

When the scribing step is completed, the process proceeds to Step 503.

Step 503: The breaking step is performed. The breaking step is a step of breaking the glass substrate 90, on which the scribing line is formed, along the scribing line. The breaking step will be described later in detail.

When the breaking step is completed, the process ends.

2-1. Initial Setting Step and Scribing Step

Hereafter, the initial setting step (Step 501) and the scribing step (Step 502) according to an embodiment of the present invention will be described.

A glass substrate 90 is transported onto a supporting table 21 included in one of a pair of substrate supporting mechanisms 20. A plurality of transporting rollers 22 moves upward, so that the glass substrate 90 is supported by the plurality of transporting rollers 22. When the plurality of transporting rollers 22 rotate, the glass substrate 90 moves toward the other supporting table 21 of the pair of the substrate supporting mechanisms 20.

Next, the glass substrate 90 is transported so as to be bridged between the pair of the substrate supporting mechanisms 20. When a predetermined cutting line of the glass substrate 90 is positioned in the vicinity of the scribing line formed by the scribing unit 40 between the pair of the substrate supporting mechanisms 20, the plurality of transporting rollers 22 moves downward. The glass substrate 90 is adsorbed by a plurality of adsorbing holes formed in the pair of the substrate supporting mechanisms 20, thereby the glass substrate 90 being fixed on the pair of the supporting tables 21.

An inclination with respect to an X direction of the glass substrate 90, a starting position of scribing and a finishing position of scribing on the glass substrate are calculated based on images of a pair of alignment marks and a glass size of the glass substrate 90, a position data of the pair of the alignment marks, etc., the images of the pair of the alignment marks formed on the glass substrate 90 being captured by the positioning cameras 17.

Next, the breaking unit 30 is slid from a waiting position of one edge portion (+X side) of the upper guide rail 12 to a side edge of −X side of the glass substrate 90, so that the pressing roller 32a opposes the starting position of scribing for the glass substrate 90 (see FIG. 2). The scribing unit 40 is slid from a waiting position of one edge portion (+X side) of the lower guide rail 13 to a side edge of −X side of the glass substrate 90. The notch forming cutter mechanism 44 is positioned at a side of the starting position of scribing for the glass substrate 90.

Next, the pressing roller 32a is moved downward by a motor (not shown) for moving upward/downward included in the pressing roller mechanism. While the pressing roller 32a is pressed against an upper surface of the glass substrate 90, the notch forming cutter mechanism 44 is moved upward by the air cylinder 44b for moving upward/downward.

Next, the breaking unit 30 and the scribing unit 40 are slid a predetermined distance in the scribing direction (+X direction) in synchronization in order to form a notch at the starting position of scribing for the glass substrate 90, this notch being formed by the edge portion 44a included in the notch forming cutter mechanism 44. As a result, the notch is formed at the starting position of scribing for the glass substrate 90 which is held by the pressing roller 32a, this notch being formed by the edge portion 44a of the notch forming cutter mechanism 44.

Next, when the notch with a predetermined length is formed at the starting position of scribing on a lower surface of the glass substrate 90, the pressing roller mechanism 33 is moved upward and the cutting mechanism 44 for making a notch is moved downward.

Next, the breaking unit 30 is slid a predetermined distance in the scribing direction (+X direction), so that the center portion of the laser beam/cooling water receiving section 35 matches an optical axis of the laser beam irradiating optical system 43. The nozzle section 42a of the cooling mechanism 42 is moved to a cooling water spraying position located above by the air cylinder 42b for moving upward/downward.

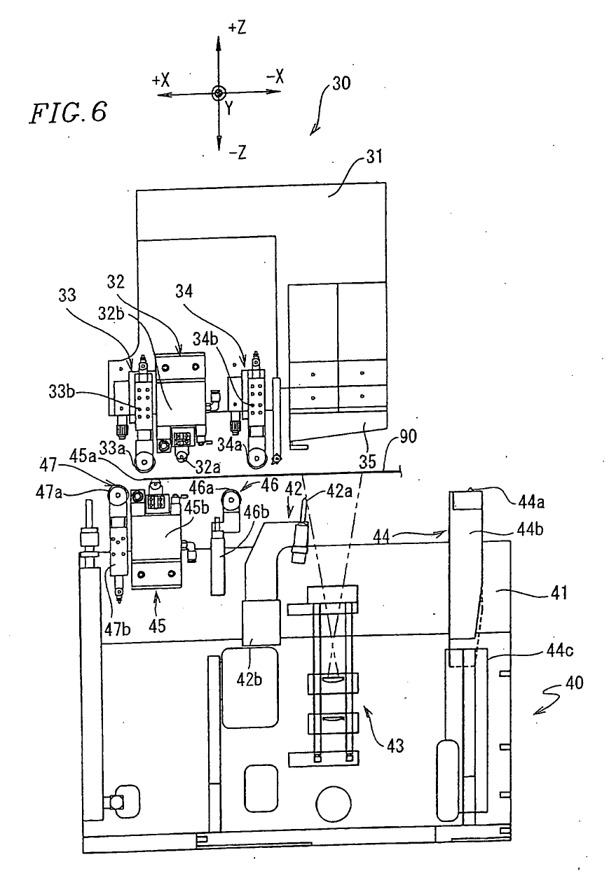

FIG. 6 shows a state in which the center portion of the laser beam/cooling water receiving section 35 matches the optical axis of the laser beam irradiating optical system 43 and the nozzle section 42a of the cooling mechanism 42 is moved to a cooling water spraying position located above by an air cylinder 42b for moving upward/downward.

Next, the breaking unit 30 and the scribing unit 40 are slid in the scribing direction (+X direction) in synchronization and the cooling water from the nozzle section 42a is sprayed upward. Furthermore, a laser beam from the laser beam irradiating optical system 43 is irradiated upward. While the laser beam is irradiated along a line to be cut (line to be scribed) of the glass substrate 90, the vicinity of the portion where the laser beam is irradiated is cooled by the cooling water. Therefore, a vertical crack is continuously formed along a position to be cut of the glass substrate 90 from the notch provided at the starting position of scribing for the glass substrate 90.

The driving section for linear interpolation is driven in order that the laser beam irradiated from the laser beam irradiating optical system 43 is irradiated along the line to be cut of the glass substrate 90. In other words, in order to address the inclination of the glass substrate 90, while the breaking unit 30 and the scribing unit 40 are slid, the upper guide rail 12 and the lower guide rail 13 are side in a direction (Y direction) which is orthogonal to the sliding direction. Thereafter, the laser beam is irradiated along the line to be cut of the glass substrate 90.

When the breaking unit 30 and the scribing unit 40 are slid from one side edge to the other side edge of the glass substrate 90, a continuous vertical crack is formed along the line to be cut (line to be scribed) of the glass substrate 90, thereby a scribing line form one side edge to the other side edge of the glass substrate 90 being formed.

Up to this point, the initial setting step (Step 501) and the scribing step (Step 502) according to Embodiment 1 of the present invention have been described.

2-2. Breaking Step

A breaking step is, for example, performed on the glass substrate 90 on which the scribing line is formed at the scribing step.

Hereafter, the breaking step (Step 503) according to Embodiment 1 of the present invention will be described in detail.

When the scribing line is formed on the glass substrate 90, the laser beam irradiated from the laser beam irradiating optical system 43 is stopped and the cooling water spraying from the cooling mechanism 42 is also stopped. The nozzle section 42a is returned to the waiting position located below.

Next, the breaking unit 30 on the upper side is slid in an opposite direction (−X direction) to the scribing direction, so that the pressing roller 32a opposes an edge portion of the formed scribing line on −X side. The scribing unit 40 on the lower side is slid such that the substrate holding roller 45a opposes the edge portion of the scribing line on −X side.

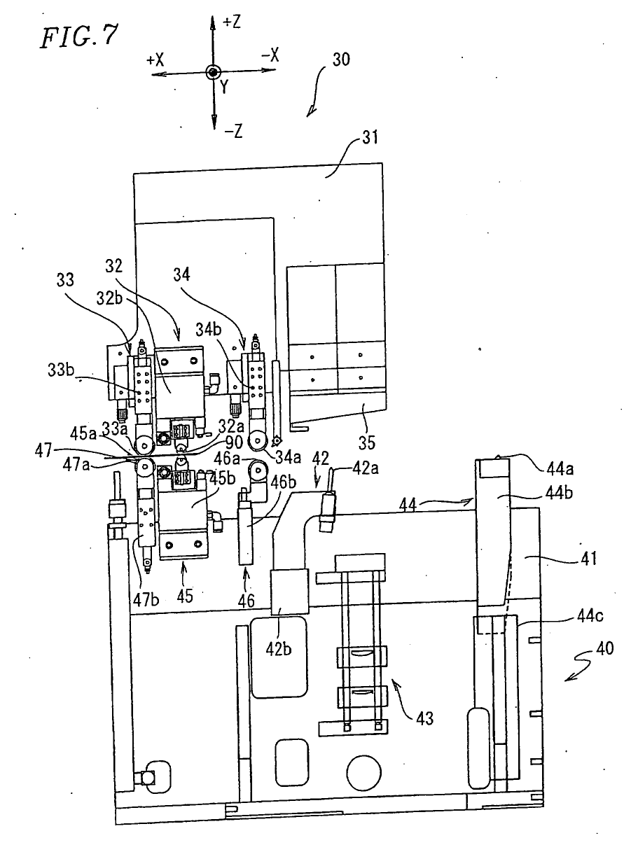

FIG. 7 shows a state in which the breaking unit 30 and the scribing unit 40 oppose each other.

Next, while the first auxiliary roller 46a is moved upward by the air cylinder 46b for moving upward/downward, the second auxiliary roller 47a is moved upward by the air cylinder 47b for moving upward/downward. The second auxiliary roller 47a contacts a lower surface of the glass substrate 90. Furthermore, when the substrate holding roller 45a is moved upward by the motor (not shown) for moving the head section 45b upward/downward, the substrate holding roller 45a contacts the lower surface of the glass substrate 90 with a predetermined pressure.

Next, the first auxiliary roller 33a on the pressing side moves downward to contact an upper surface portion of the glass substrate 90, this upper surface portion opposing the position which the second auxiliary roller 47a contacts. The pressing roller 32a is moved downward by the motor (not shown) for moving the head section 32d upward/downward to be contacted upon the upper surface portion of the glass substrate 90 with a predetermined pressure, this upper surface portion opposing the substrate holding roller 45a.

Furthermore, the second auxiliary roller 34a on the pressing side moves downward after moving to the vicinity of the end face portion of the glass substrate 90 on −X side. Thereafter, the second auxiliary roller 34a on the pressing side contacts the upper surface portion of the glass substrate 90 which corresponds to the position the first auxiliary roller 46a contacts.

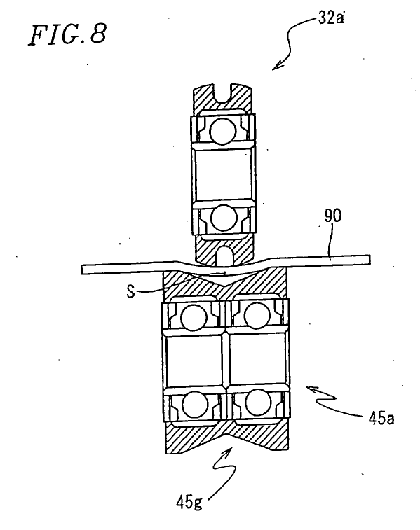

FIG. 8 show a state in which the pressing roller 32a with an outer circumferential surface thereof recessed in a V-shape and flat side edge portions on both sides of the substrate holding roller 45a in the width direction are pressed upon both sides of the scribing line formed on the glass substrate 90.

The center portion of the U-shaped groove section 45g of the substrate holding roller 45a opposes the scribing line S formed on the glass substrate 90, this U-shaped groove section 45g being formed in the center portion of the substrate holding roller 45a in the width direction. The groove section 45g formed in the substrate holding roller 45a is formed such that the substrate holding roller 45a does not contact with the scribing line S. The groove section formed in the pressing roller 32a is formed such that the pressing roller 32a does not contact with the line opposing the scribing line S.

The pressing roller 32a is pressed upon the upper surface portion of the glass substrate 90 which is adjacent to the scribing line S, not upon the lower surface portion of the glass substrate 90 which is held by side edge portions of both sides of the substrate holding roller 45a since the dimension of the pressing roller 32a in the width direction is smaller than that of the substrate holding roller 45a (e.g., the dimension of the pressing roller 32a is about one half of that of the substrate holding roller 45a) . The pressing roller 32a is, for example, set so as to reach the position of equal to or more than 0.3 mm from the upper surface of the glass substrate 90. Accordingly, the glass substrate 90 is bent so as to project downward with the scribing line at the center. The vertical crack at the edge portion of the scribing line S on −X side extends in the thickness direction of the glass substrate 90 to reach the upper surface of the glass substrate 90, this vertical crack being formed on the lower surface of the glass substrate 90. As a result, the glass substrate 90 is broken.

In this manner, when a groove section is formed in the pressing roller 32a such that the pressing roller 32a does not contact with the line on the second surface of the glass substrate 90, this line opposing the scribing line S, the pressing roller 32a presses upon both sides of the line on the second surface of the glass substrate 90 so as not to contact the line, on the second surface of the brittle substrate, opposing the scribing line when the glass substrate 90 is cut along the scribing line. Therefore, occurrence of chippings at the cut face portion is prevented during the cutting process.

A groove section is formed in the substrate holding roller 45a so as not contact the scribing line. Therefore, when the glass substrate 90 is cut along the scribing line, the substrate holding roller 45a can hold both sides of the scribing line so as not to contact the scribing line. Therefore, occurrence of chippings at the cut face portion is prevented during the cutting process.

When the width of the groove section formed in the substrate holding roller 45a is larger than that of the pressing roller 32a, the glass substrate 90 is positively cut along the scribing line since a portion of the pressing roller 32a goes under the groove section of the substrate holding roller 45a, thereby the glass substrate 90 likely to bend.

Next, when breaking of the glass substrate 90 is started along the scribing line at the position of edge portion of the scribing line on −X side, the pressing roller 32a is slightly moved upward. As a result, the amount to which the pressing roller 32a presses into the glass substrate 90 slightly decreases. In this case, the pressing roller 32a is set so as to reach the position of equal to or less than 0.3 mm from the upper surface of the glass substrate 90.

Next, the breaking unit 30 and the scribing unit 40 are slid in the scribing direction (+X direction) in synchronization. As a result, the pressing roller 32a is pressed against the both side portions of the scribing line 9, which is held by the substrate holding roller 45a, so that the substrate holding roller 45a and the pressing roller 32a respectively rolls on the upper surface and the lower surface of the glass substrate 90 to continuously break the glass substrate 90 along the scribing line S from the position of the edge portion of the scribing line S on −X side.

The first auxiliary roller 33a on the pressing side and the second auxiliary roller 47a positioned ahead of the pressing roller 32a in the sliding direction hold the area ahead of the scribing line to be cut by pressing from both directions. Therefore, when the glass substrate 90 is broken along the scribing line by the pressing force of the pressing roller 32a, occurrence of chippings, fractures, etc., which are the cause for a product defect after the glass substrate is cut, is prevented. An unnecessary force generated within the glass substrate 90 being bent is prevented from affecting on the portion being broken.

The glass substrate 90 which is cut along the scribing line S while being broken is held by the first auxiliary roller 46a and the second auxiliary roller 34a on the pressing side which are arranged at a predetermined distance from the substrate holding roller 45a. Therefore, bending of the cut glass substrate 90 is prevented. Since an unnecessary force does not work on the portion being broken, there is not possibility that chippings, fractures, etc., which are the cause for a product defect after the glass substrate 90 is cut, occurs.

In this manner, when the breaking unit 30 and the scribing unit 40 are slid in the scribing direction (+X direction) and reach the side edge of the glass substrate 90 on +X side, the glass substrate 90 is cut along the entire scribing line S.

Next, the second auxiliary roller 47a is moved downward, the substrate holding roller 45a is moved downward, and then the first auxiliary roller 46a is moved downward, so that all of the rollers are separated from the lower surface of the glass substrate 90. The first auxiliary roller 33a on the pressing side is moved upward, the pressing roller 32a and the second auxiliary roller 34a on the pressing side are moved upward, so that all of the rollers are separated from the glass substrate 90.

Next, the breaking unit 30 and the scribing unit 40 are respectively slid to move to the waiting position of the edge portions of the upper guide rail 12 and the lower guide rail 13.

Up to this point, the breaking step (Step 503) according to the embodiment of the present invention has been described in detail.

According to the cutting method of the present invention, the glass substrate 90 on which the scribing line is formed is positively cut along the scribing line. Moreover, a working efficiency improves since the glass substrate 90 is cut immediately subsequent to the formation of the scribing line. Furthermore, unnecessary force is not applied to the uncut scribe line S when the glass substrate 90 is cut. There is no possibility that chippings occur at the end face of the cut glass substrate since the out glass substrate 90 does not bend.

### EMBODIMENT 2

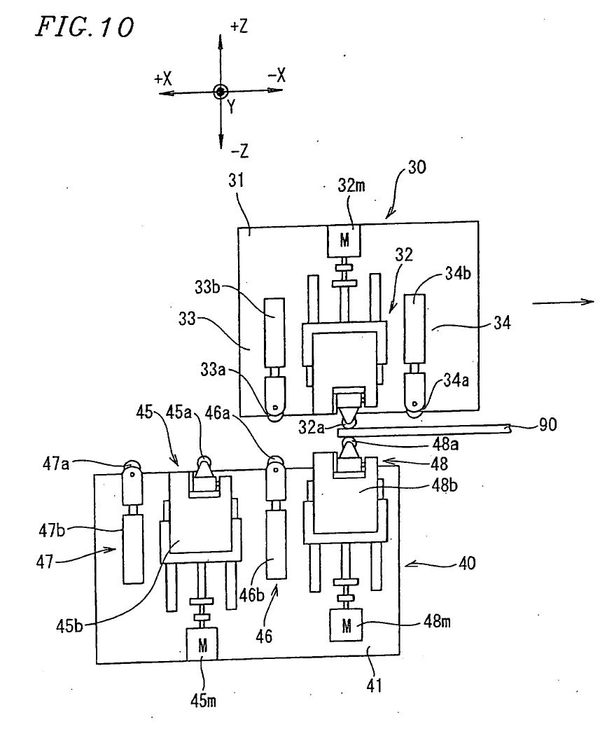

FIG. 10 is a view schematically showing a breaking unit 30 and a scribing unit 40 according to Embodiment 2 of the present invention.

In Embodiment 2 of the present invention, a laser beam irradiating optical system 43 and a cooling mechanism 42 which are arranged in Embodiment 1 of the present invention are not provided in the scribing unit 40. A scribing cutter mechanism 48 is provided instead of the notch forming cutter mechanism 44.

In the scribing cutter mechanism 48, a cutter wheel tip 48a is rotatably provided at upper end portion of a cutter head 48b, which is movable upward/downward, attached to the scribing unit body 41. As a cutter wheel tip 48a, a wheel cutter in which recessed portions are provided on an outer circumference ridge with, a predetermined distance is preferably used, wherein the wheel cutter is disclosed in Japanese Laid-Open Publication No. 09-188534. However, a normal cutter wheel tip may be used.

Instead of the cutter wheel tip 48a, a cutter wheel can be used in which a pressing farce (load), applied to a cutter by applying a vibrating force involved with a surrounding elasticity of an oscillating actuator, periodically changes, this cutter being pressed upon a surface of a brittle material substrate thereby, pinpoint shock being applied to the brittle material substrate. One example is disclosed in Japanese patent No. 2954566. Accordingly, the example is not described in detail herein.

The cutter head 48b moves upward/downward by a ball screw mechanism having a motor 48m.

In the case where a cutter is used as a scribing ling forming means, a scribing line is stably formed due to a wide selection for conditions of forming a scribing line. In the case where a disk-shaped cutter wheel tip is used as a cutter and edge portions are formed in an outer circumferential edge of the cutter wheel tip, a scribing line is formed while the cutter wheel tip is pressed and rotated on the brittle substrate. Therefore, a speed (scribing forming speed) of forming a scribing line is improved.

In the case where a plurality of recessed portions are formed in ridge-shaped sections of the edge portions with a predetermined distance, a plurality of protrusions are formed at positional location except where the plurality of recessed portions are formed. When a scribing line is formed, the plurality of protrusions applies a pinpoint shock upon a first surface of the brittle substrate. Therefore, a vertical crack which extends up to about 90% of the thickness of the brittle substrate is formed. As a result, the brittle substrate is positively cut after the breaking step.

In the case where a cutter is movable separately from a pressing means, a brittle substrate on which a scribing line is formed is cut when the pressing means follows the cutter at the time the scribing line is formed. While the scribing line is formed on the first surface of the brittle substrate, a second surface of the brittle substrate is pressed by the pressing means. Therefore, the scribing step and the breaking step are approximately simultaneously performed. Accordingly, time for a cutting step is reduced.

Similar to the scribing unit 40 of the cutting apparatus according to Embodiment 1, in the scribing unit body 41 according to Embodiment 2, a first auxiliary roller mechanism 46 is provided adjacent to a cutter mechanism 48 for scribing, and a substrate holding roller mechanism 45 and a second auxiliary roller mechanism 47 are provided adjacent to the first auxiliary roller mechanism 46. In the cutting apparatus according to Embodiment 2 of the present invention, the substrate holding roller mechanism 45 is moved upward/downward by the ball screw mechanism having the motor 45m. The other structures for the scribing unit body 41 are essentially the same as those for the previously-described scribing unit 40.

Similar to the breaking unit 30 of the cutting apparatus according to Embodiment 1, in the breaking unit 30 according to Embodiment 2, a pressing roller mechanism 32, a first auxiliary roller mechanism 33 on the pressing side and a second auxiliary roller mechanism 34 on the pressing side are provided in a breaking unit body 31. The pressing roller mechanism 32 is moved upward/downward by a ball screw mechanism having a motor 32m. The structures of the breaking unit 30 according to Embodiment 2 are essentially same as those for the breaking unit 30 according to Embodiment 1.

In the cutting apparatus having the breaking unit 30 and the scribing unit 40 with such structures according to Embodiment 2 of the present invention, while the cutter wheel tip 48a is positioned at a side edge of a starting position (on +X side of a glass substrate 90) of forming a scribing line, the pressing roller 32a is positioned so as to oppose the cutter wheel tip 48a. The breaking unit 30 and the scribing unit 40 are slid in synchronization in the scribing direction (−X direction), and thereafter, the cutter wheel tip 48a is pressed and rotated along a line to be cut (line to be scribed) of the glass substrate 90. Thereby, the scribing line is formed along the line to be cut (line to be scribed).

When the scribing line is formed on the glass substrate 90, the breaking unit 30 and scribing unit 40 are slid in synchronization in a direction (+X direction) opposite to the scribing direction by the cutter wheel tip 48a.

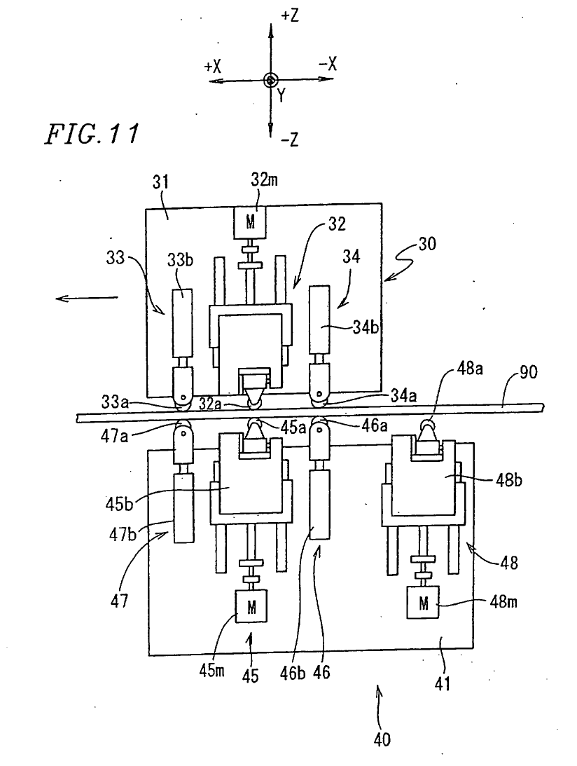

FIG. 11 shows that the glass substrate 90 is cut along the scribing line when the pressing roller 32a is sequentially pressed upon both side portions of the scribing line of the glass substrate 90 which is held by the substrate holding roller 45a.

The second auxiliary roller mechanism 47 moves on a surface of the glass substrate 90 along the scribing line while holding the glass substrate 90 and the first auxiliary roller mechanism 33 on the pressing side moves on a surface of the glass substrate 90 along the scribing line while holding the glass substrate 90.

The holding means is moved along the scribing line while holding the uncut portions of the area on which the scribing line is formed, thereby preventing an unnecessary force being applied to the areas which are being pressed by the pressing means. As a result, chippings at the cut face portion formed on the glass substrate 90 can be prevented.

Since the substrate holding roller mechanism 45, the second auxiliary roller mechanism 47, the first auxiliary roller mechanism 46 and the pressing means move at the same speed, the glass substrate 90 is firmly held by the second auxiliary roller mechanism 47 and the first auxiliary roller mechanism 46.

The first auxiliary roller mechanism 46 is moved on a surface of the glass substrate 90 along the scribing line while holding the cut portions of the area on which the scribing line is formed, and the first holding means is moved along the scribing line while the second auxiliary roller mechanism 34 on the pressing side holds the glass substrate 90, thereby preventing an unnecessary force being applied to the areas which are being pressing by the substrate holding roller mechanism 45. As a result, chippings at the cut face portion formed on the brittle substrate can be prevented.

### EMBODIMENT 3

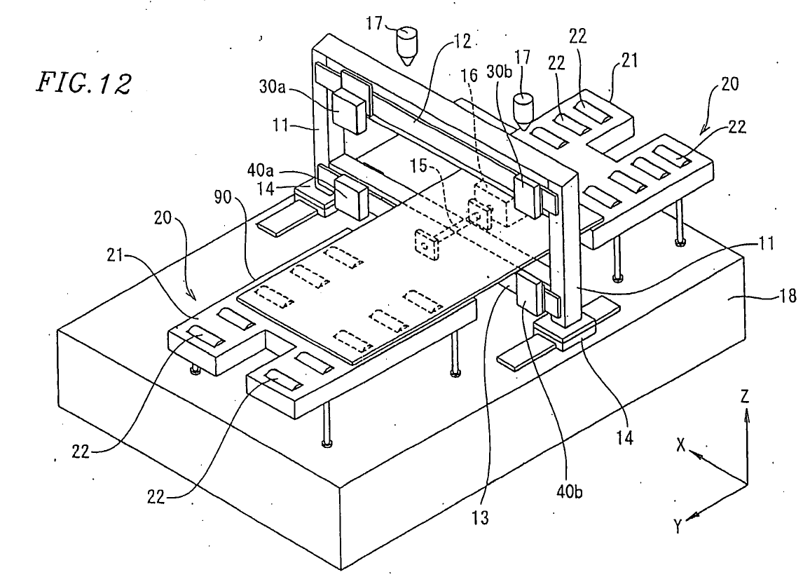

FIG. 12 is a perspective view showing a cutting apparatus according to Embodiment 3 of the present invention.

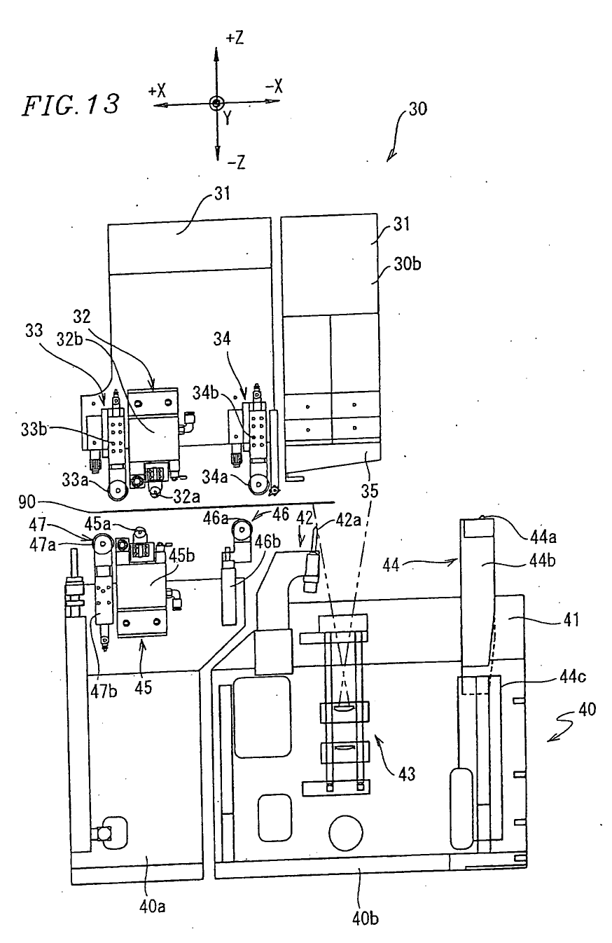

FIG. 13 is a front view showing a breaking unit 30 and a scribing unit 40 included in the cutting apparatus according to Embodiment 3 of the present invention.

The breaking unit 30 included in the cutting apparatus according to Embodiment 3 of the present invention includes a first upper unit 30a and a second upper unit 30b. The first upper unit 30a includes the pressing roller mechanism 32, the first auxiliary roller mechanism 33 on the pressing side and the second auxiliary roller mechanism 34 on the pressing side of the breaking unit 30 according to Embodiment 1. The second upper unit 30b includes a laser beam/cooling water receiving section 35. Since the laser beam/cooling water receiving section 35 prevents diffusion of at least one of a laser beam and a cooling medium, thereby improving the safety of the cutting apparatus 100. The first upper unit 30a and the second upper unit 30b are respectively separately slid along the upper guide rail 12 powered by a linear motor mechanism.

The scribing unit 40 included in the cutting apparatus according to Embodiment 3 of the present invention includes a first lower unit 40a and a second lower unit 40b. The first lower unit 40a integrally includes a first auxiliary roller mechanism 46, a substrate holding roller mechanism 45 and a second auxiliary roller mechanism 47 of the scribing unit 40 according to Embodiment 1. The second lower unit 40b integrally includes a notch forming cutter mechanism 44 and a laser beam irradiating optical system 43 and a cooling mechanism 42. The first lower unit 40a and the second lower unit 40b are respectively separately slid along the lower guide rail 13 powered by a linear motor mechanism.

In this manner, according to the breaking unit 30 and the scribing unit 40 of the cutting apparatus according to Embodiment 3 of the present invention, an apparatus operation (operation for the scribing step and operation for breaking step) according to processing conditions for various brittle material substrates can be selected.

The other structures for Embodiment 3 are same as those for to Embodiment 1.

In the cutting apparatus according to Embodiment 3, when a scribing line is formed on the glass substrate 90, similar to Embodiment 1, the first upper unit 30a and the second lower unit 40b are slid from the respective waiting positions and moved to the side edge portion of the glass substrate 90 on −X side, so that the pressing roller 32a opposes the edge portion of the glass substrate 90 and the notch forming cutter mechanism 44 is positioned at a side of a starting position of forming a scribing line, which is at the edge portion of the glass substrate 90 on −X side.

Next, the pressing roller mechanism 32 moves downward and the pressing roller 32a, contacts an upper surface of the glass substrate 90 with a predetermined pressure. The notch forming cutter mechanism 44 is moved upward by an air cylinder 44c for moving upward/downward. Next, the first upper unit 30a and the second lower unit 40b are slid a predetermined distance in the scribing direction (+X direction) in order that a notch is formed at the starting position of forming a scribing line for the glass substrate by an edge portion 44a of the notch forming cutter mechanism 44. As a result, the notch is formed at the starting position of scribing for the glass substrate 90 by the edge portion 44a of the notch forming cutter mechanism 44.

When the notch is formed with a predetermined length at the starting position of forming a scribing line, then the notch forming cutter mechanism 44 of the second lower unit 40b moves downward.

Next, the second lower unit 40b is slid and positioned so as that an optical axis of the laser beam irradiating optical system 43 matches the notch. After the first upper unit 30a is slid to the waiting position, the second upper unit 30b is slid from the waiting position such that the center portion of the laser beam/cooling water receiving section 35 in the sliding direction match the optical axis of the laser beam irradiating optical system 43.

In the case where the cooling nozzle is movable along the scribing line, the cooling nozzle is moved along the scribing line. Therefore, a scribing condition can be set according to the material of the brittle substrate.

A notch is positively formed at the starting position of forming a scribing line on the glass substrate 90 by the notch forming cutter mechanism. In the case where the notch forming cutter mechanism is integrally movable with the laser beam irradiating means and the cooling means, the notch formed at the starting position of forming a scribing line, and a laser beam irradiating area and a cooling area are co-aligned. Therefore, the scribing line is accurately formed along the line on which a scribing line is to be formed.

FIG. 13 shows a state in which the optical axis of the laser beam irradiating optical system 43 matches the notch, and the center portion of the laser beam/cooling water receiving section 35 in the sliding direction matches the optical axis of the laser beam irradiating optical system 43.

Next, the second upper unit 30b and the second lower unit 40b are moved in synchronization in the scribing direction (+X direction), so that the scribing line is formed by the irradiation of the laser beam and the spraying of the cooling water.

Next, while the first upper unit 30b and the second lower unit 40b are slid to the waiting position which is at a side of the starting position of forming a scribing line, the first upper unit 30a and the first lower unit 40a are slid in the same direction. At the starting position of forming a scribing line, while the pressing roller 32a is pressed against both sides of the scribing line, the substrate holding roller 45a is pressed against the lower surface of the glass substrate 90.

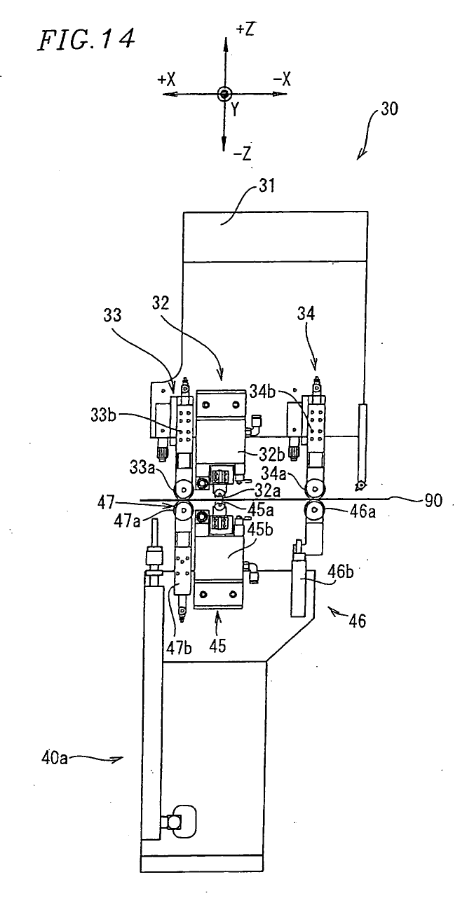

Next, when only the second upper unit 30a and the first lower unit 40a are slid in synchronization in the same direction (+X direction) as the scribing direction, the glass substrate 90 is broken along the scribing line by a pressing force applied by the pressing roller 32a of the first upper unit 30a and the substrate holding roller 45a of the first lower unit 40a similar to that of the above-described Embodiment 1 as shown in FIG. 14.

### EMBODIMENT 4

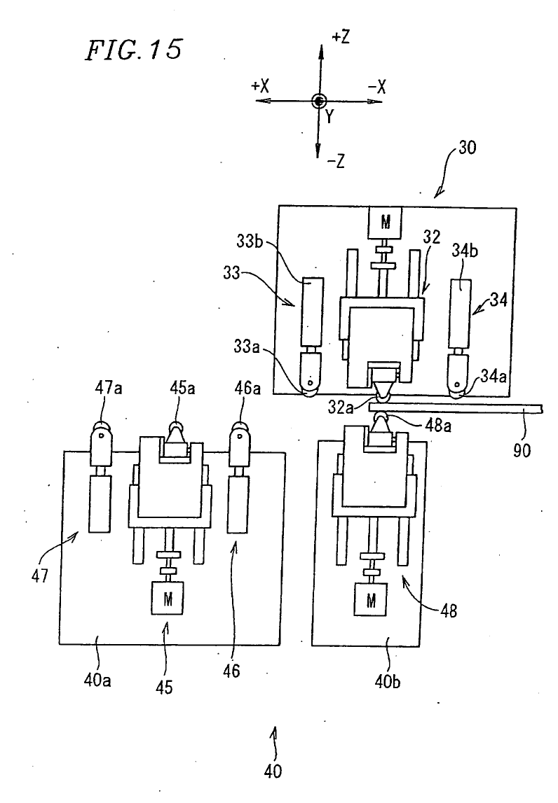

FIG. 15 is a front view showing a structure of a breaking unit 30 and a scribing unit 40 provided in the cutting apparatus according to Embodiment 4 of the present invention.

The scribing unit 40 in the cutting apparatus according to Embodiment 4 includes a first lower unit 40a and a second lower unit 40b. The first lower unit 40a includes
a first auxiliary roller mechanism 46, a substrate holding roller mechanism 45 and a second auxiliary roller mechanism 47 of the scribing unit 40 according to Embodiment 2. The second lower unit 40b includes a scribing cutter mechanism 48 which is separated from the first lower unit 40a.

The first lower unit 40a and the second lower unit 40b are respectively separately slid along a lower guide rail 13 by powered by a linear motor mechanism.

In this manner, according to the cutting apparatus of Embodiment 4 of the present invention, an apparatus operation (operation for the scribing step and operation for breaking step) according to processing conditions for various brittle material substrates can be selected.

The other structures for Embodiment 4 are the same as those for to Embodiment 2.

In the cutting apparatus according to Embodiment 4, when the scribing line is formed on the glass substrate 90, first, the second lower unit 40b is slid from the waiting position which is at one edge portion of the lower guide rail 13 to the starting position of forming a scribing line which is at a side edge of the glass substrate 90 on +X direction, so that a cutter wheel tip 48a of the scribing cutter mechanism 48 opposes the starting position of forming a scribing line. A breaking unit 30 is slid as well, so that the pressing roller 32a of the breaking unit 30 is positioned so as to oppose the cutter wheel tip 48a (see FIG. 15).

Next, when the breaking unit 30 and the scribing unit 40 are slid in synchronization in the scribing direction (−X direction), the pressing roller and the cutter wheel tip 48a are respectively pressed against an upper surface and a lower surface of the glass substrate along a line to be cut (line to be scribed). Thereby, a scribing line is formed on the glass substrate 90 along the line to be cut (line to be scribed).

Next, the second lower unit 40b is slid to the same direction (−X direction) as the sliding direction so as to be positioned at the waiting position, which is at a side of the glass substrate 90.

Next, the first lower unit 40a is slid below the pressing roller 32a, of the breaking unit 30 positioned at an end face position of the scribing line, so that the pressing roller 32a and the substrate holding roller 45a oppose each other with the glass substrate 90 therebetween.

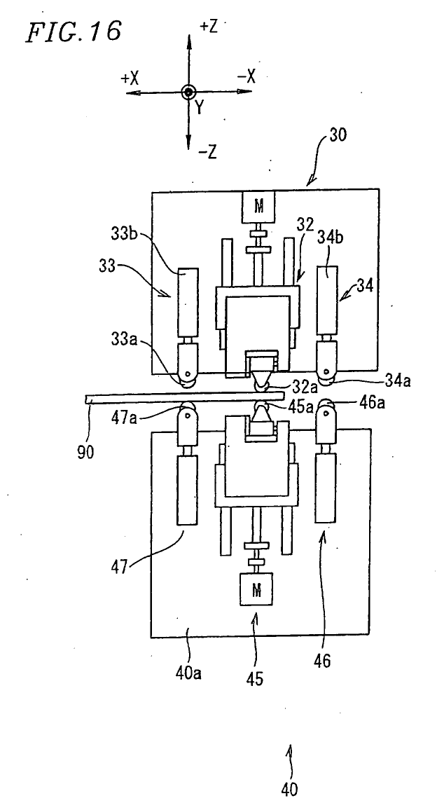

FIG. 16 shows a state in which the pressing roller 32a and substrate holding roller 45a oppose each other with the glass substrate 90 therebetween.

Next, while the pressing roller 32a and the substrate holding roller 45a contact the glass substrate 90, a first auxiliary roller 33a on the pressing side and a second auxiliary roller 47a respectively contact the glass substrate 90, and the first auxiliary roller 46a moves upward. The breaking unit 30 and the first lower unit 40a are slid in synchronization in the opposite direction (+X direction) to the scribing direction by the cutter wheel tip 48a.

The second auxiliary roller 34a on the pressing side moves downward and contacts the glass substrate 90 after moving to the vicinity of an end face portion of the glass substrate 90 on −X side.

According to the cutting apparatus corresponding to Embodiment 4 of the present invention, when the breaking unit 30 and the first lower unit 40a are slid along the entire scribing line, the pressing roller 32a is sequentially pressed and rotated upon both side portions of the scribing line of the glass substrate 90 which is held by the substrate holding roller 45a, so that the glass substrate 90 is cut along the scribing line.

### EMBODIMENT 5

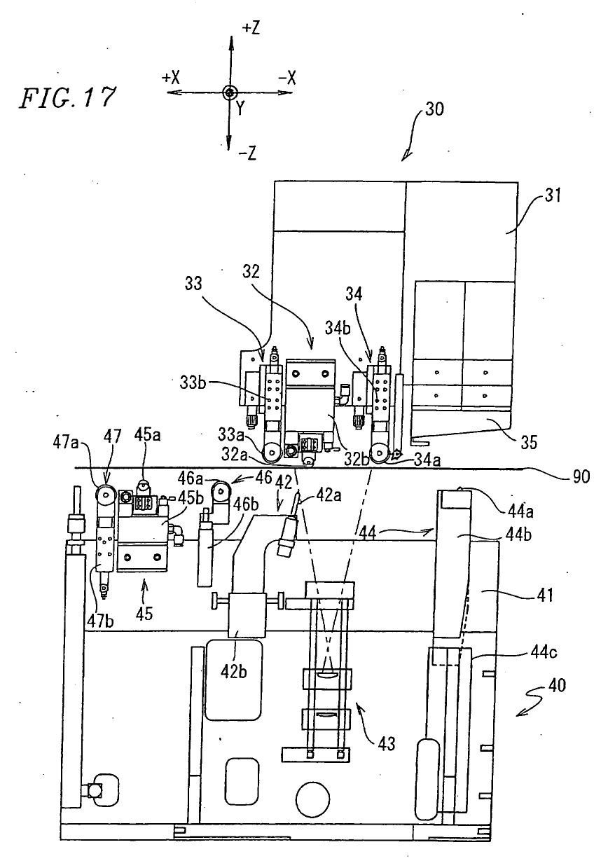

FIG. 17 is a front view showing a structure of a breaking unit 30 and a scribing unit 40 provided in a cutting apparatus according to Embodiment 5 of the present invention.

In the cutting apparatus according to Embodiment 5, a nozzle section 42a of a cooling mechanism in the scribing unit 40 according to Embodiment 1 is slidable in the sliding direction of the scribing unit 40 (see FIG. 17). The other structures for Embodiment 5 are same as those for to Embodiment 1.

In Embodiment 5, when a scribing line is formed, a pressing roller 32a of the breaking unit 30 is pressed against an upper surface of a glass substrate 90 (see FIG. 17). Therefore, portions on which a scribing line is formed bend downward.

Next, the nozzle section 42a of the scribing unit 40 is slid such that cooling water is sequentially sprayed onto the portions which have been bent by the pressing force of the pressing roller 32A.

When the cooling water is sprayed onto the vicinity of the portions which are irradiated by a laser beam, the portions to be sprayed by the cooling water is bent downward. Therefore, a vertical crack which is formed, from a lower surface of the glass substrate 90, by the irradiation of the laser beam and the spraying of the cooling water, extends upward and reaches near the upper surface of the glass substrate 90.

Next, the glass substrate 90 is cut in the same manner as Embodiment 1.

According to the cutting apparatus according to Embodiment 5, the vertical crack formed right below the scribing line reaches near the upper surface of the glass substrate 90. Therefore, the glass substrate 90 is positively cut after the breaking step which uses a roller according to the present application.

### EMBODIMENT 6

In the cutting apparatus according to Embodiment 2 of the present invention, when a scribing line is formed on the glass substrate 90 by the cutter wheel tip 48a, a pressing force of the pressing roller 32a with respect to the glass substrate 90 is larger than that of the cutter wheel 48a with respect to the glass substrate 90 when the pressing roller 32a of the breaking unit 30 is pressed against the glass substrate 90. In this manner, when the glass substrate 90 is scribed along the line to be scribed by the cutter wheel tip 48a, the vertical crack right below the scribing line extends to reach the upper surface of the glass substrate 90 with the glass substrate 90 bent downward.

In the cutting apparatus according to Embodiment 1 of the present invention, when the scribing line is formed by the irradiation of the laser beam and the spraying of the cooling water, the glass substrate can be bent downward by pressing the pressing roller 32a and the auxiliary roller 33a on the pressing side, provided in the breaking unit 30, against the glass substrate 90.

### EMBODIMENT 7

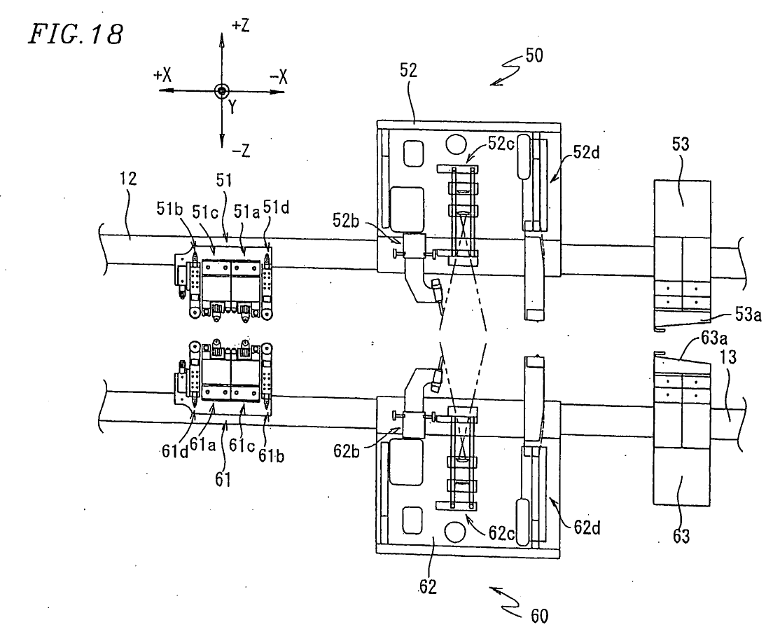

FIG. 18 is a view schematically showing a structure of a cutting apparatus according to Embodiment 7.

The cutting apparatus according to Embodiment 7 is used for cutting a bonded glass substrate 91 for which a pair of glass substrates 90 is bonded.

The cutting apparatus according to Embodiment 7 includes a upper guide rail 12, a first upper unit 51, a second upper unit 52, a third upper unit 53, a lower guide rail 13, a first lower unit 61, a second lower unit 62 and a third lower unit 63.

The first upper unit 51, the second upper unit 52 and the third upper unit 53 are attached to the upper guide rail 12 so as to each separately slidable. The first lower unit 61, the second lower unit 62 and the third lower unit 63 are attached to the lower guide rail 13 so, as to each be separately slidable.

The first upper unit 51 includes a pressing roller mechanism 51a, a first auxiliary roller mechanism 51b, a substrate holding roller mechanism 51c and a second auxiliary roller mechanism 51d. The pressing roller mechanism 51a has the same structure as that for the pressing roller mechanism 32 in the first upper unit 30a according to Embodiment 3. The first auxiliary roller mechanism 51b has the same structure as the first auxiliary roller mechanism 33 on the pressing side in the first upper unit 30a according to Embodiment 3. The substrate holding roller mechanism 52c is provided between the pressing roller mechanism 51a and the first auxiliary roller mechanism 51b. The substrate holding roller mechanism 51c has the same structure as that for the substrate holding roller mechanism 45 according to Embodiment 3. The second auxiliary roller mechanism 51d is provided on a side opposite to the substrate holding roller mechanism 51c with respect to the pressing roller mechanism 51a. The second auxiliary roller mechanism 51d has the same structure as that for the first auxiliary roller mechanism 51b.

The second upper unit 52 has a structure in which the second lower unit 40b according to Embodiment 3 is inverted in a vertical direction. A cooling mechanism 52b, a laser beam irradiating optical system 52c and a notch forming cutter mechanism 52d are provided in this order from the side of the first upper unit 51.

A third upper unit 53 includes a laser beam/cooling water receiving section 53a has a similar structure to that for the second upper unit 30b according to Embodiment 3 does.

The first lower unit 61 has a structure in which the first upper unit 51 is inverted in vertical and horizontal directions. A second auxiliary roller mechanism 61d, a pressing roller mechanism 61a, a substrate holding roller mechanism 61c and a first auxiliary roller mechanism 61b areprovided in this order from the side of the first auxiliary roller mechanism 51b.

The second lower unit 62 has a similar structure to that for the second lower unit 40b according to Embodiment 3. A cooling mechanism 62d, a laser beam irradiating optical system 62c and a notch forming cutter mechanism 62d are provided in this order from the side of the first lower unit 61.

The third lower unit 63 has a structure in which the third upper unit 53 is inverted in a vertical direction. The third lower unit 63 includes a laser beam/cooling water receiving section 63a.

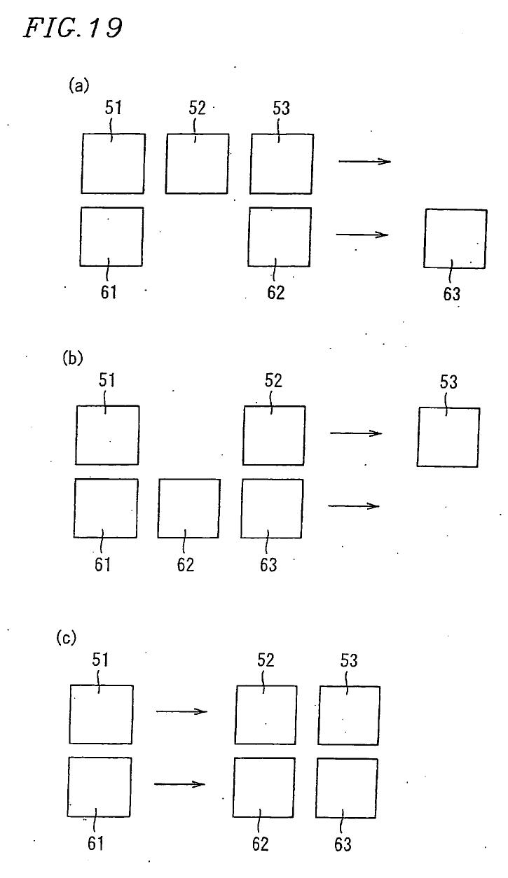

FIG. 19 is a view for illustrating an operation of the cutting apparatus according to Embodiment 7.

Hereafter, the operation of the cutting apparatus according to Embodiment 7 will be described with reference to FIG. 19.

A scribing line is formed on a lower glass substrate of a bonded substrate. In order to form the scribing line, first, the third lower unit 63 is slid to a waiting position, which is at a side of an end face portion in ascribing direction (see FIG. 19(a)), and thereafter, the scribing line is formed on the lower glass substrate by using the second lower unit 62 and the third upper unit 53. This method of forming a scribing line is the same as the method of forming a scribing line on the glass substrate 90 according to Embodiment 3.

Next, first, the third lower unit 53 in the upper unit 50 is slid to a waiting position which is a side of an end face portion in ascribing direction (see FIG. 19 (b)), the scribing line is formed on the upper glass substrate by using the second upper unit 52 in the upper unit 50 and the third lower unit 63 in the lower unit 60. This method of forming a scribing line is the same as the method of forming a scribing line on the lower glass substrate.

Next, while the second upper unit 52 is slid to a side of the third upper unit 53 of a waiting position which is a side of an end face portion in the scribing direction, the second lower unit 62 is slid to a side of the third lower unit 63 of a waiting position which is a side of an end face portion in the scribing direction (see FIG. 19(c)). The first upper unit 51 and the first lower unit 61 oppose each other. At the same time, the first auxiliary roller mechanism 51b, the substrate holding roller mechanism 53c, the pressing roller mechanism 51a and the second auxiliary roller mechanism 51d respectively oppose the second auxiliary roller mechanism 61d, the pressing roller mechanism 61a, the substrate holding roller mechanism 61c and the first auxiliary roller mechanism 61b and are also respectively connected to the bonded substrate. The first upper unit 51 and the first lower unit 61 are slid in synchronization along the scribing line in the scribing direction.

According to Embodiment 7 of the present invention, when both sides of the scribing line formed on the upper glass substrate of the bonded glass substrate 91 is pressed by the pressing roller mechanism 61a through the lower glass substrate, the upper glass substrate is cut along the scribing line. When both sides of the scribing line formed on the lower glass substrate are pressed by the pressing roller mechanism 51a through the upper glass substrate, the lower glass substrate is cut along the scribing line. Furthermore, when the upper glass substrate and the lower glass substrate are cut, the bonded substrate is pinched between the second auxiliary roller mechanism 51d and the first auxiliary roller mechanism 61b at a portion ahead of a scribing position in the scribing direction. Therefore, when each of the scribing lines on the upper glass substrate and the lower glass substrate is broken, occurrence of chippings, fractures, etc., is prevented since an unnecessary force does not work on each part in the bonded substrate to be broken.

Furthermore, the cut upper glass substrate and the cut lower glass substrate prevent the bonded substrate from bending since the first auxiliary roller mechanism 51b and the second auxiliary roller mechanism 61d hold the bonded substrate.

As described above, the bonded substrate is efficiently cut by using the cutting apparatus according to Embodiment 7.

According to the cutting apparatus of Embodiment 7, a pressing force upon a second surface of the bonded substrate, which opposes a first surface of the bonded substrate, is movable along the scribing line formed on the first surface of the bonded substrate while the first surface of the bonded substrate is held, in this manner, while the pressing force is moved along the scribing line formed on the first surface of the bonded substrate, a pressing force works on the second surface of the bonded substrate which opposes the first surface of the bonded substrate. Therefore, a bending moment which is generated when the scribing line is formed on the first surface of the bonded substrate and which positively extends a vertical crack extending from the surface of the first surface in the thickness direction of the bonded substrate can work on the brittle substrate to cut the bonded substrate.

### EMBODIMENT 8

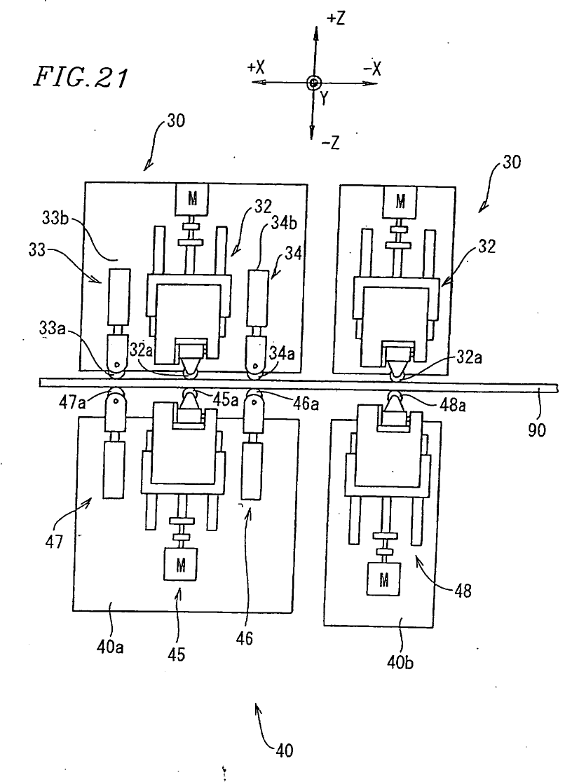

FIG. 21 is a front view showing a structure of breaking units 30 and a scribing unit 40 provided in the cutting apparatus according to Embodiment 8 of the present invention.

The structure for the cutting apparatus according to Embodiment 8 is the same as that for Embodiment 4 except that the cutting apparatus according to Embodiment 8 uses two breaking units 30.

In the cutting apparatus in Embodiment 8, when a scribing line is formed on a glass substrate 90, a pressing roller and a cutter wheel tip 48a are respectively pressed and rotated upon the upper surface and the lower surface along a line to be cut (line to be scribed). Thereby, a scribing line is formed on the glass substrate 90 along the line to be cut (line to be scribed).

At the same time, the first lower unit 40a is slid below a pressing roller 32a in the breaking unit 30 which is positioned at the end-face position of the scribing line, so that the pressing roller 32a and a substrate holding roller 45a oppose each other with the glass substrate 90 therebetween.

While the pressing roller 32a and the substrate holding roller 45a are contacted to the glass substrate, a first auxiliary roller 33a on the pressing side and a second auxiliary roller 47a are respectively contacted to the glass substrate 90 and the second auxiliary roller on the pressing side and a first auxiliary roller 46a are respectively contacted to the glass substrate 90. The breaking units 30 and the first lower unit 40a are slid in synchronization in the same direction (+X direction) as the scribing direction by cutter wheel tip 48a.

According to embodiment 8, the pressing means is moved along the scribing line while the holding means and the pressing means oppose each other with a brittle substrate therebetween and while a scribing forming means forms a scribing line on ascribing line forming surface of the brittle substrate. Therefore, a scribing step and a breaking step on the brittle substrate are approximately simultaneously performed. As a result, time of cutting step for the brittle substrate can be reduced.

In Embodiments 1 to 8 of the present invention, when a scribing line is formed on a glass substrate, the glass substrate is vibrated such that a vertical crack which constitutes the scribing line readily extends.

The first auxiliary roller mechanism 33 on the pressing side and the second auxiliary roller mechanism 34 on the pressing side, the first auxiliary roller mechanisms 46, 51b, 61b and the second auxiliary roller mechanisms 47, 51c, 61c can be omitted as appropriate according to the thickness and dimension of a glass substrate 90 which is intended to be broken.

As described above, the present invention is illustrated by using preferred embodiments of the present invention. However, the present invention is not limited to the embodiments. It is understood that the scope of the present invention is only construed by the scope of the claim. It is understood that those skilled in the art can arrive at an invention of an equivalent scope based on the description of the present invention and common general technical knowledge from the description of the specific preferred embodiments of the present invention. It is understood that the contents of the patent publications, the published applications and the documents cited in the present specification, and cited as references for the present application and are incorporated by reference herein.

### INDUSTRIAL APPLICABILITY

According to a brittle substrate cutting system and a brittle substrate cutting method of the present invention, a pressing force upon a second surface of a brittle substrate, which opposes a first surface of the brittle substrate, is moved along the scribing lane formed on the first surface of the brittle substrate while the first surface of the brittle substrate is held. In this manner, while the pressing force is moved along the scribing line formed on the first surface of the brittle substrate, the pressing force can work on the second surface of the brittle substrate which opposes the first surface of the brittle substrate. Therefore, a bending moment, which positively extends a vertical crack extending from the scribing line in the thickness direction of the substrate, can work on the brittle substrate to cut the brittle substrate.

A combination of a holding means and a pressuring means can accurately cut a brittle substrate or a bonded substrate while the substrate is firmly held by a six-wheel roller or an eight-wheel roller.

1. A brittle substrate cutting system comprising:
a scribing apparatus including a scribing line forming means for forming a scribing line on a first surface of a brittle substrate; and
a breaking apparatus for breaking the brittle substrate along the scribing line,
wherein the breaking apparatus includes a pressing means for pressing a second surface of the brittle substrate, a first holding means for holding the first surface of the brittle substrate, and a first pressing controlling means for controlling the pressing means such that the pressing means moves along a scribing line while the pressing means presses the second surface of the brittle substrate opposing the first surface of the brittle substrate with the first surface of the brittle substrate is being held by the first holding means,
wherein a groove section is formed in the pressing means such that the pressing means does not contact with a line on the second surafce of the brittle substrate, the line opposing the scribing line.

2. A brittle substrate cutting system according to claim 1, wherein the first pressing controlling means controls the pressing means such that the pressing means moves along the scribing line while the first holding means and the pressing means oppose each other with the brittle substrate therebetween.

3. A brittle substrate cutting system according to claim 1, wherein the first pressing controlling means controls the pressing means such that the pressing means rolls along the scribing line.

4. A brittle substrate cutting system according to claim 3, wherein the pressing means is a roller.

5. A brittle substrate cutting system according to claim 3, wherein the pressing means is a conveyor.

6. A brittle substrate cutting system according to claim 3, wherein the pressing means is a bearing.

7. (canceled)

8. A brittle substrate cutting system according to claim 1, wherein the breaking apparatus further comprises a first holding controlling means for controlling the first holding means such that the first holding means moves along the scribing line while the first holding means and the pressing means oppose each other with the brittle substrate therebetween.

9. A brittle substrate cutting system according to claim 8, wherein the first holding controlling means controls the first holding means such that the first holding means rolls along the scribing line.

10. A brittle substrate cutting system according to claim 9, wherein the holding means is a roller.

11. A brittle substrate cutting system according to claim 9, wherein the holding means is a conveyor.

12. A brittle substrate cutting system according to claim 9, wherein the holding means is a bearing.

13. A brittle substrate cutting system according to claim 1, wherein a groove section is formed in the first holding means such that the first holding means does not contact with the scribing line.

14. A brittle substrate cutting system according to claim 13, wherein the width of the groove section formed in the first holding means is larger than that of the pressing means.

15. A brittle substrate cutting system according to claim 1, wherein the pressing means further comprises a second holding means and a third holding means for moving along the scribing line in a first direction and for holding the brittle substrate, the second holding means and the third holding means being arranged in the first direction from the pressing means, and
the breaking apparatus further comprises a second holding controlling means for controlling the second holding means such that the second holding means moves on the first surface along the scribing line while the second holding means holds the brittle substrate, and controlling the third holding means such that the third holding means moves on the second surface along the scribing line while the third holding means holds the brittle substrate.

16. A brittle substrate cutting system according to claim 15, wherein the second holding controlling means controls the second holding means such that the first holding means and the second holding means move at a predetermined speed and the second holding controlling means controls the third holding means such that the third holding means and the pressing means move at the predetermined speed while the second holding means and the third holding means oppose each other with the brittle substrate therebetween.

17. A brittle substrate cutting system according to claim 1, wherein the pressing means further comprises a fourth holding means and a fifth holding means for moving along the scribing line in a first direction and for holding the brittle substrate, the fourth holding means and the fifth holding means being arranged in a direction opposite to the first direction from the pressing means.

18. A brittle substrate cutting system according to claim 1, wherein the scribing line forming means comprises a laser beam irradiating means for irradiating a laser beam on the first surface of the brittle substrate and a cooling means for cooling the vicinity of the portions of the first surface of the brittle substrate where the laser beam is irradiated by the laser beam irradiating means.

19. A brittle substrate cutting system according to claim 18, wherein the cooling means is a cooling nozzle, and the cooling nozzle cools the vicinity of the portions where the laser beam is irradiated by spraying a cooling medium on the first surface of the brittle substrate.

20. A brittle substrate cutting system according to claim 19, comprising a laser beam/cooling medium receiving section for receiving at least one of the laser beam irradiated by the laser beam irradiating means and the cooling medium sprayed by the cooling nozzle.

21. A brittle substrate cutting system according to claim 20, wherein the laser beam/cooling medium receiving section is movable separately from the pressing means.

22. A brittle substrate cutting system according to claim 19, wherein the cooling nozzle is movable along the scribing line.

23. A brittle substrate cutting system according to claim 18, wherein the scribing line forming means further comprises a notch forming cutter mechanism for forming a notch at a starting position of forming the scribing line on the first surface of the brittle substrate.

24. A brittle substrate cutting system according to claim 23, wherein the notch forming cutter mechanism is integrally movable with the laser beam irradiating means and the cooling means.

25. A brittle substrate cutting system according to claim 1, wherein the scribing line forming means is a cutter.

26. A brittle substrate cutting system according to claim 25, wherein the cutter is a disk-shaped cutter wheel tip, and an edge portion is formed in an outer circumferential edge of the cutter wheel tip.

27. A brittle substrate cutting system according to claim 26, wherein a plurality of recessed portions are formed in a ridge-shaped section of the edge portion with a predetermined distance.

28. A brittle substrate cutting system according to claim 25, wherein the cutter is movable separately from the pressing means.

29. A brittle substrate cutting system according to claim 1, wherein the first pressing controlling means controls the pressing means such that the pressing means moves along the scribing line while the first holding means and the pressing means oppose each other with the brittle substrate therebetween and while the scribing line forming means form a the scribing line on the first surface of the brittle substrate.

30. A brittle substrate cutting system according to claim 1, wherein the scribing apparatus comprises a scribing line forming means for forming the scribing line on the first surface of the brittle substrate while the first surface of the brittle substrate is held, and
the breaking apparatus further comprises a pressing means for pressing the second surface opposing the first surface of the brittle substrate.

31. A brittle substrate cutting system according to claim 1, wherein the brittle substrate is a bonded substrate obtained by bonding a first substrate and a second substrate,
the scribing apparatus comprises a first scribing forming means for forming a first scribing line on a first surface of the bonded substrate and a second scribing line forming means for forming a second scribing line on a second surface of the bonded substrate opposing the first surface of the bonded substrate,
the breaking apparatus breaks the bonded substrate along the first scribing line and breaks the bonded substrate along the second scribing line, and
wherein the breaking apparatus further includes a first bonded substrate pressing means for pressing a second surface of the bonded substrate, a first bonded substrate holding means for holding the first surface of the bonded substrate, and the first pressing controlling means for controlling the first bonded substrate pressing means such that the first bonded substrate pressing means moves along the scribing line while the first bonded substrate pressing means presses the second surface of the bonded substrate opposing the first surface of the bonded substrate with the first surface of the bonded substrate being held by the first bonded substrate holding means,
wherein a first groove section is formed in the first bonded substrate pressing means such that the first bonded substrate pressing means does not contact with a line on the second surface of the bonded substrate, the line opposing the first scribing line.

32. A brittle substrate cutting system according to claim 30, wherein the breaking apparatus further comprises:
a second bonded substrate pressing means for pressing the first surface of the bonded substrate;
a second bonded substrate holding means for holding the second surface of the bonded substrate; and
a second pressing controlling means for controlling the second bonded substrate pressing means such that the second bonded substrate pressing means moves along the scribing line while the second bonded substrate pressing means presses the first surface of the bonded substrate opposing the second surface of the bonded substrate with the second surface of the bonded substrate being held by the second bonded substrate holding means,
wherein a second groove section is formed in the second bonded substrate pressing means such that the second bonded substrate pressing means does not contact with a line on the first surface of the bonded substrate, the line opposing the second scribing line.

33. A brittle substrate cutting system according to claim 32, wherein the brittle substrate cutting system comprises a first controlling means for the pressing means for controlling the first bonded substrate pressing means such that the first bonded substrate pressing means moves along the first scribing line while the first bonded substrate holding means and the first bonded substrate pressing means oppose each other with the bonded substrate therebetween, and
a second controlling means for the pressing means for controlling the second bonded substrate pressing means such that the second bonded substrate pressing means moves along the second scribing line while the second bonded substrate holding means and the second bonded substrate pressing means oppose each other with the bonded substrate therebetween.

34. A brittle substrate cutting system according to claim 33, wherein the first controlling means for the pressing means controls the first bonded substrate pressing means such that the first bonded substrate pressing means rolls along the first scribing line, and
the second controlling means for the pressing means controls the second bonded substrate pressing means such that the second bonded substrate pressing means rolls along the second scribing line.

35. A brittle substrate cutting system according to claim 34, wherein the first bonded substrate pressing means and the second bonded substrate pressing means are rollers.

36. A brittle substrate cutting system according to claim 34, wherein the pressing means is a conveyor.

37. A brittle substrate cutting system according to claim 34, wherein the pressing means is a bearing.

38. A brittle substrate cutting system according to claim 32, wherein the breaking apparatus further comprises a first controlling means for the holding means for controlling the first bonded substrate holding means such that the first bonded substrate holding means moves along the first scribing line while the first bonded substrate holding means and the first bonded substrate pressing means oppose each other with the bonded substrate therebetween, and
a second controlling means for the holding means for controlling the second bonded substrate holding means such that the second bonded substrate holding means moves along the second scribing line while the second bonded substrate holding means and the second bonded substrate pressing means oppose each other with the bonded substrate therebetween.

39. A brittle substrate cutting system according to claim 38, wherein the first controlling means for the holding means controls the first bonded substrate holding means such that the first bonded substrate holding means rolls along the first scribing line, and
the second controlling means for the holding means controls the second bonded substrate holding means such that the second bonded substrate holding means rolls along the second scribing line.

40. A brittle substrate cutting system according to claim 39, wherein the first bonded substrate holding means and the second bonded substrate holding means are rollers.

41. A brittle substrate cutting system according to claim 39, wherein the first bonded substrate holding means and the second bonded substrate holding means are conveyors.

42. A brittle substrate cutting system according to claim 39, wherein the first bonded substrate holding means and the second bonded substrate holding means are bearings.

43. A brittle substrate cutting system according to claim 38, wherein a third groove section is formed in the first bonded substrate holding means such that the first bonded substrate holding means does not contact with the first scribing line, and
a fourth groove section is formed in the second bonded substrate holding means such that the second bonded substrate holding means does not contact with the second scribing line.

44. A brittle substrate cutting method according to claim 43, wherein the width of the third groove section formed in the first bonded substrate holding means is larger than the first groove section of the first bonded substrate pressing means, and the width of the fourth groove section formed in the second bonded substrate holding means is larger than the second groove section of the second bonded substrate pressing means.

45. A brittle substrate cutting method according to claim 32, wherein the first bonded substrate pressing means and the second substrate pressing means move in a first direction along the first scribing line and the second scribing line, and the brittle substrate cutting system further comprises a third bonded substrate holding means and a fourth bonded substrate holding means respectively for holding the brittle substrate in the first direction from the first bonded substrate pressing means and the second bonded substrate pressing means, and
the breaking apparatus further comprises a third controlling means for the holding means for controlling the third bonded substrate holding means such that the third bonded substrate holding means moves on the first surface along the first scribing line while the third bonded substrate holding means holds the bonded substrate, and controlling the fourth bonded substrate holding means such that the fourth bonded substrate holding means moves on the second surface along the second scribing line while the fourth bonded substrate holding means holds the bonded substrate.

46. A brittle substrate cutting system according to claim 45, wherein the third controlling means for the holding means controls the third bonded substrate holding means such that the third bonded substrate holding means, the first bonded substrate holding means and the second bonded substrate pressing means move at a predetermined speed and the third controlling means for the holding means controls the fourth bonded substrate holding means such that the fourth bonded substrate holding means, the second bonded substrate holding means and the first bonded substrate pressing means move at the predetermined speed while the third bonded substrate holding means and the fourth bonded substrate holding means oppose each other with the bonded substrate therebetween.

47. A brittle substrate cutting system according to claim 32, wherein the first bonded substrate pressing means moves in the first direction along the second scribing line,
the second bonded substrate pressing means moves in the first direction along the first scribing line, and
the brittle substrate cutting system further comprises a fifth bonded substrate holding means and a sixth bonded substrate holding means respectively for holding the brittle substrate in a direction opposite to the first direction from the first bonded substrate pressing means and the second bonded substrate pressing means.

48. A brittle substrate cutting system according to claim 33, wherein the first controlling means for the pressing means controls the first bonded substrate pressing means such that the first bonded substrate pressing means moves along the first scribing line and the second controlling means for the pressing means controls the second bonded substrate pressing means such that the second bonded substrate pressing means moves along the second scribing line while the first bonded substrate holding means and the first bonded substrate pressing means oppose each other with the bonded substrate therebetween, the first scribing line forming means forms the first scribing line on the first surface of the bonded substrate, the second bonded substrate holding means and the second bonded substrate pressing means oppose each other with the bonded substrate therebetween and the second scribing line forming means forms the second scribing line on the second surface of the bonded substrate.

49. A brittle substrate cutting method, comprising the steps of:
(a) forming a scribing line on a first surface of a brittle substrate; and
(b) breaking the brittle substrate along the scribing line, and
the step (b) is performed by a breaking apparatus for breaking the brittle substrate along the scribing line.
the breaking apparatus includes:
a pressing means for pressing the second surface of the brittle substrate; and
a first holding means for holding the first surface of the brittle substrate,
the step (b) includes the step of:
(b-1) controlling the pressing means such that the pressing means moves along the scribing line while the pressing means presses the second surface of the brittle substrate opposing the first surface of the brittle substrate with the first surface of the brittle substrate being held by the first holding means,
wherein a groove section is formed in the pressing means such that the pressing means does not contact with a line on the second surface of the brittle substrate, the line opposing the scribing line.

50. A brittle substrate cutting method according to claim 49, wherein the step (b-1) includes the step of moving the pressing means along the scribing line while the first holding means and the pressing means oppose each other with the brittle substrate therebetween.

51. A brittle substrate cutting method according to claim 49, wherein the step (b-1) includes the step of controlling the pressing means such that the pressing means rolls along the scribing line.

52. A brittle substrate cutting method according to claim 51 wherein the pressing means is a roller.

53. A brittle substrate cutting method according to claim 51 wherein the pressing means is a conveyor.

54. A brittle substrate cutting method according to claim 51 wherein the pressing means is a bearing.

55. (canceled)

56. A brittle substrate cutting method according to claim 49, wherein the step (b) further includes the step of:
(b-2) controlling the first holding means such that the first holding means moves along the scribing line while the first holding means and the pressing means oppose each other with the brittle substrate therebetween.

57. A brittle substrate cutting method according to claim 56, wherein the step (b-2) includes the step of controlling the first holding means such that the first holding means rolls along the scribing line.

58. A brittle substrate cutting method according to claim 57, wherein the holding means is a roller.

59. A brittle substrate cutting method according to claim 57, wherein the holding means is a conveyor.

60. A brittle substrate cutting method according to claim 57, wherein the holding means is a bearing.

61. A brittle substrate cutting method according to claim 49, wherein a groove section is formed in the first holding means such that the first holding means does not contact with the scribing line.

62. A brittle substrate cutting method according to claim 61, wherein the width of the groove section formed on the first holding means is larger than that of the pressing means.

63. A brittle substrate cutting method according to claim 49, wherein the pressing means moves along the scribing line in a first direction and further comprises a second holding means and a third holding means for holding the brittle substrate in the first direction from the pressing means,
the step (b) further includes the step of:
(b-3) controlling the second holding means such that the second holding means moves on the first surface along the scribing line while the second holding means holds the brittle substrate, and controlling the third holding means such that the third holding means moves on the second surface along the scribing line while the third holding means holds the brittle substrate.

64. A brittle substrate cutting method according to claim 63, wherein the step (b-3) includes the step of controlling the second holding means such that the first holding means and the second holding means move at a predetermined speed, and controlling the third holding means such that the third holding means and the pressing means move at the predetermined speed while the second holding means and the third holding means oppose each other with the brittle substrate therebetween.

65. A brittle substrate cutting method according to claim 49, wherein the pressing means moves in a first direction along the scribing line and further comprises a fourth holding means and a fifth holding means for holding the brittle substrate in a direction opposite to the first direction from the pressing means.

66. A brittle substrate cutting method according to claim 49, wherein the step (a) includes the steps of:
(a-1) irradiating a laser beam on the first surface of the brittle substrate; and
(a-2) cooling the vicinity of the portions of the first surface of the brittle substrate where the laser beam is irradiated by the laser beam irradiating means.

67. A brittle substrate cutting method according to claim 66, wherein the step (a-2) is performed by a cooling medium
the cooling means is a cooling nozzle, and the cooling nozzle cools the vicinity of the portions where the laser beam is irradiated, by spraying a cooling medium on the first surface of the brittle substrate.

68. A brittle substrate cutting method according to claim 67, wherein the step (a-1) is performed by a laser beam irradiating means and includes the step of receiving at least one of the laser beam irradiated by the laser beam irradiating means and the medium sprayed by the cooling nozzle.

69. A brittle substrate cutting method according to claim 68, wherein the step of receiving at least one of the laser beam irradiated by the laser beam irradiating means and the medium sprayed by the cooling nozzle is performed by a laser beam/cooling medium receiving section, and the laser beam/cooling medium receiving section is movable separately from the pressing means.

70. A brittle substrate cutting method according to claim 68, wherein the cooling nozzle is movable along the scribing line.

71. A brittle substrate cutting method according to claim 66, wherein the step (a) further includes the step of forming a notch at a starting position of forming the scribing line on the first surface of the brittle substrate.

72. A brittle substrate cutting method according to claim 71, wherein the step of forming a notch is performed by a notch forming cutter mechanism, and
the notch forming cutter mechanism is integrally movable with the laser beam irradiating means and the cooling means.

73. A brittle substrate cutting method according to claim 49, wherein the step (a) is performed by a scribing line forming means, and
the scribing line forming means is a cutter.

74. A brittle substrate cutting method according to claim 73, wherein the cutter is a disk-shaped cutter wheel tip, and an edge portion is formed in an outer circumferential edge of the cutter wheel tip.

75. A brittle substrate cutting method according to claim 74, wherein a plurality of recessed portions are formed in a ridge-shaped section of the edge portion with a predetermined distance.

76. A brittle substrate cutting method according to claim 73, wherein the cutter is movable separately from the pressing means.

77. A brittle substrate cutting method according to claim 49, wherein the step (b-1) controls the pressing means such that the pressing means moves along the scribing line while the first holding means and the pressing means oppose each other with the brittle substrate therebetween and while the scribing line forming means forms the scribing line on the first surface of the brittle substrate.

78. A brittle substrate cutting method according to claim 49, wherein the step (a) further includes the step of forming the scribing line on the first surface of the brittle substrate while the first surface of the brittle substrate is held, and
the step (b) further includes the step of pressing a second surface opposing the first surface of the brittle substrate.

79. A brittle substrate cutting method according to claim 49, wherein the brittle substrate is a bonded substrate obtained by bonding substrates,
the step (a) performed by a scribing apparatus for forming a scribing line on a first surface of the brittle substrate,
the scribing apparatus comprises a first scribing forming means for forming a first scribing line on a first surface of the bonded substrate and a second scribing line forming means for forming a second scribing line on a second surface of the bonded substrate opposing the first surface of the bonded substrate,
the step (b-1) is performed by a first bonded substrate pressing means for pressing the second surface of the bonded substrate and a first bonded substrate holding means for holding the first surface of the bonded substrate;
the step (b-1) includes the steps of:
breaking the bonded substrate along the first scribing line and breaking the bonded substrate along the second scribing line, and
controlling the first bonded substrate pressing means such that the first bonded substrate pressing means moves along the scribing line while the first bonded substrate pressing means presses the second surface of the bonded substrate opposing the first surface of the bonded substrate with the first surface of the bonded substrate being held by the first bonded substrate holding means,
wherein a first groove section is formed in the first bonded substrate pressing means such that the first bonded substrate pressing means does not contact with a line on the second surface of the bonded substrate, the line opposing the first scribing line.

80. A brittle substrate cutting method according to claim 49, wherein the a breaking apparatus further comprises
a second bonded substrate pressing means for pressing the first surface of the bonded substrate; and
a second bonded substrate holding means for holding the second surface of the bonded substrate;
the step (b-1) further includes
the second pressing controlling means for controlling the second bonded substrate pressing means such that the second bonded substrate pressing means moves along the scribing line while the second bonded substrate pressing means presses the first surface of the bonded substrate opposing the second surface of the bonded substrate with the second surface of the bonded substrate being held by the second bonded substrate pressing means,
wherein a second groove section is formed in the second bonded substrate pressing means such that the second bonded substrate pressing means does not contact with a line on the first surface of the bonded substrate, the line opposing the second scribing line.

81. A brittle substrate cutting method according to claim 80, wherein the brittle substrate cutting method comprises the steps of:
controlling the first bonded substrate pressing means such that the first bonded substrate pressing means moves along the first scribing line while the first bonded substrate holding means and the first bonded substrate pressing means oppose each other with the bonded substrate therebetween; and
controlling the second bonded substrate pressing means such that the second bonded substrate pressing means moves along the second scribing line while the second bonded substrate holding means and the second bonded substrate pressing means oppose each other with the bonded substrate therebetween.

82. A brittle substrate cutting method according to claim 80, wherein the step (b-1) includes the steps of:
controlling the first bonded substrate pressing means such that the first bonded substrate pressing means rolls along the first scribing line; and
controlling the second bonded substrate pressing means such that the second bonded substrate pressing means rolls along the second scribing line.

83. A brittle substrate cutting method according to claim 82, wherein the first bonded substrate pressing means and the second bonded substrate pressing means are rollers.

84. A brittle substrate cutting method according to claim 82, wherein the pressing means is a conveyor.

85. A brittle substrate cutting method according to claim 81, wherein the pressing means is a bearing.

86. A brittle substrate cutting method according to claim 80, wherein the step (b) further includes the steps of:
(b-2) controlling the first bonded substrate holding means such that the first bonded substrate holding means moves along the first scribing line while the first bonded substrate holding means and the first bonded substrate pressing means oppose each other with the bonded substrate therebetween, and controlling the second bonded substrate holding means such that the second bonded substrate holding means moves along the second scribing line while the second bonded substrate holding means and the second bonded substrate pressing means oppose each other with the bonded substrate therebetween.

87. A brittle substrate cutting method according to claim 86, wherein the step (b-2) includes the step of controlling the first bonded substrate holding means such that the first bonded substrate holding means rolls along the first scribing line, and controlling the second bonded substrate holding means such that the second bonded substrate holding means rolls along the second scribing line.

88. A brittle substrate cutting method according to claim 87, wherein the first bonded substrate holding means and the second bonded substrate holding means are rollers.

89. A brittle substrate cutting method according to claim 87, wherein the first bonded substrate holding means and the second bonded substrate holding means are conveyors.

90. A brittle substrate cutting method according to claim 87, wherein the first bonded substrate holding means and the second bonded substrate holding means are bearings.

91. A brittle substrate cutting method according to claim 86, wherein a third groove section is formed in the first bonded substrate holding means such that the first bonded substrate holding means does not contact with the first scribing line, and
a fourth groove section is formed in the second bonded substrate holding means such that the second bonded substrate holding means does not contact with the second scribing line.

92. A brittle substrate cutting method according to claim 86, wherein the width of the third groove section formed in the first bonded substrate holding means is larger than the first groove section of the first bonded substrate pressing means, and the width of the fourth groove section formed in the second bonded substrate holding means is larger than the second groove section of the second bonded substrate pressing means.

93. A brittle substrate cutting method according to claim 80, wherein the first bonded substrate pressing means and the second substrate pressing means respectively move in a first direction along the first scribing line and the second scribing line, and the brittle substrate cutting method further comprises the use of a third bonded substrate holding means and a fourth bonded substrate holding means respectively for holding the brittle substrate in the first direction from the first bonded substrate pressing means and the second bonded substrate pressing means,
the step (b) further includes the step of:
(b-3) controlling the third bonded substrate holding means such that the third bonded substrate holding means moves on the first surface along the first scribing line while the third bonded substrate holding means holds the bonded substrate, and controlling the fourth bonded substrate holding means such that the fourth bonded substrate holding means moves on the second surface along the second scribing line while the fourth bonded substrate holding means holds the bonded substrate.

94. A brittle substrate cutting method according to claim 93, wherein the step (b-3) includes the step of:
controlling the third bonded substrate holding means such that the third bonded substrate holding means, the first bonded substrate holding means and the second bonded substrate pressing means move at a predetermined speed and the third controlling means for the holding means controls the fourth bonded substrate holding means such that the fourth bonded substrate holding means, the first bonded substrate holding means and the second bonded substrate pressing means move at the predetermined speed while the third bonded substrate holding means and the fourth bonded substrate holding means oppose each other with the bonded substrate therebetween.

95. A brittle substrate cutting method according to claim 80, wherein the first bonded substrate pressing means moves in the first direction along the second scribing line,
the second bonded substrate pressing means moves in the first direction along the first scribing line,
the brittle substrate cutting method further comprises the use of a fifth bonded substrate holding means and a sixth bonded substrate holding means respectively for holding the brittle substrate in a direction opposite to the first direction from the first bonded substrate pressing means and the second bonded substrate pressing means.

96. A brittle substrate cutting method according to claim 80, comprising the step of controlling the second bonded substrate pressing means such that the first bonded substrate pressing means moves along the first scribing line and controlling the second bonded substrate pressing means such that the second bonded substrate pressing means moves along the scribing line while the first bonded substrate holding means and the first bonded substrate pressing means oppose each other with the bonded substrate therebetween, the first scribing line forming means forms the first scribing line on the first surface of the bonded substrate, the second bonded substrate holding means and the second bonded substrate pressing means oppose each other with the bonded substrate therebetween and the second scribing line forming means forms the second scribing line on the second surface of the bonded substrate.
